(19) United States
(12) Patent Application Publication
(10) Pub. No.: US 2013/0293388 A1
(43) Pub. Date: Nov. 7, 2013

(54) CELLULAR TANK MONITORING TECHNOLOGY

(71) Applicants: Daryl Ingalsbe, Spicer, MN (US); Jim Fangmeier, Paynesville, MN (US)

(72) Inventors: Daryl Ingalsbe, Spicer, MN (US); Jim Fangmeier, Paynesville, MN (US)

(21) Appl. No.: 13/860,354

(22) Filed: Apr. 10, 2013

Related U.S. Application Data
(60) Provisional application No. 61/622,331, filed on Apr. 10, 2012.

(51) Int. Cl. G01D 4/00

(52) U.S. Cl. CPC G01D 4/002
USPC 340/870.02

(57) ABSTRACT

A system, apparatus and method for monitoring the status and use of an LP fuel tank using cellular communication technology. The system includes a sensor unit communicatively connected to a storage tank, the sensor unit measuring the level of fluid in the storage tank and transmitting fluid level data externally via a cellular data communication link, a remote host unit disposed remotely from the storage tank, the host unit receiving fluid level data from the sensor unit via the cellular data communication link, and a base unit disposed in the vicinity of the storage tank by a user, the base unit receiving fluid level data from the sensor unit via the cellular data communication link or via an RF link.

### CROSS REFERENCE TO RELATED APPLICATIONS, IF ANY

This application claims the benefit under 35 U.S.C. §119(e) of co-pending U.S. Provisional Patent Application Ser. No. 61/622,331, filed Apr. 10, 2012, which is hereby incorporated by reference.

### 37 C.F.R. §1.71(E) AUTHORIZATION

A portion of the disclosure of this patent document contains material which is subject to copyright protection. The copyright owner has no objection to the facsimile reproduction by anyone of the patent document or the patent disclosure, as it appears in the US Patent and Trademark Office patent file or records, but otherwise reserves all copyright rights whatsoever.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND OF THE INVENTION

1. Field of the Invention

The present invention relates, generally, to monitoring and metering systems, apparatus and methods. More particularly, the invention relates to remote electronic metering apparatus and methods of monitoring the level of fluids in storage tanks and other aspects of such tanks, such as in the case of liquid propane (LP) storage tanks, and for reporting and analyzing such fluid level and other information. Most particularly, the invention relates to a system, apparatus and method for remotely monitoring and reporting the status and use of an LP storage tank using cellular communication technology. The techniques of the invention can also be used in other fields.

2. Background Information

Existing technology in this field is believed to have significant limitations and shortcomings.

All US patents and patent applications, and all other published documents mentioned anywhere in this application are incorporated by reference in their entirety.

### BRIEF SUMMARY OF THE INVENTION

The present invention provides a cellular metering apparatus and methods which are practical, reliable, accurate, safe and efficient, and which are believed to constitute an improvement over the background technology.

The invention includes the following aspects:
1. A system for monitoring the level and use of fluids in a storage tank, comprising a sensor unit adapted to be communicatively connected to a storage tank, the sensor unit measuring the level of fluid in the storage tank and transmitting fluid level data externally via at least a cellular data communication link, a remote host unit adapted to be disposed remotely from the storage tank, the host unit receiving fluid level data from the sensor unit via the cellular data communication link, and a base unit adapted to be disposed in the vicinity of the storage tank by a user, the base unit receiving fluid level data from the sensor unit via the cellular data communication link or via an RF link.
2. A sensor unit adapted to be communicatively connected to a fluid storage tank, the sensor unit measuring the level of fluid in the storage tank and transmitting fluid level data to a remote means to receive and process information via at least a cellular data communication link.
3. A host unit adapted to be disposed remotely from a fluid storage tank, the host unit receiving fluid level data from a sensing means which is communicatively connected to the storage tank, the host unit receiving fluid level data via a cellular data communication link.
4. A base unit adapted to be disposed in a vicinity of a fluid storage tank, the base unit receiving fluid level data from a sensing means communicatively connected to the storage tank via a cellular data communication link or an RF link.
5. A method for monitoring the level and use of fluids in a storage tank, comprising a. providing a monitoring system including
i. a sensor unit adapted to be communicatively connected to a storage tank, the sensor unit measuring the level of fluid in the storage tank and transmitting fluid level data externally via at least a cellular data communication link,
ii. a host unit adapted to be disposed remotely from the storage tank, the host unit receiving fluid level data from the sensor unit via the cellular data communication link, and
iii. at base unit adapted to be disposed in the vicinity of the storage tank, the base unit receiving fluid level data from the sensor unit via the cellular data communication link or an RF link.
   b. connecting the sensor unit to the storage tank and monitoring the level of fluid in the storage tank;
   c. communicating fluid level data from the sensor to the host unit via the cellular data link;
   d. processing fluid level data at the host unit;
   e. communicating fluid level data from the sensor to the base unit via the cellular data link or an RF link; and
   f. processing fluid level data at the base unit.

The present invention is believed to involve novel elements, combined in novel ways to yield more than predictable results. The problems solved by the invention were not fully recognized in the prior art.

The aspects, features, advantages, benefits and objects of the invention will become clear to those skilled in the art by reference to the following description, claims and drawings.

### BRIEF DESCRIPTION OF THE SEVERAL VIEWS OF THE DRAWING

The present invention, and the manner and process of making and using it, will be better understood by those skilled in the art by reference to the following drawings.

FIG. 1 is a perspective view of an embodiment of the cellular tank monitor (CTM) of the present invention.

FIG. 2 is a perspective view of the cellular tank monitor, showing an embodiment of the housing of the monitor.

FIG. 3 is a top view thereof.

FIG. 4 is a bottom view thereof.

FIG. 5 is a front view thereof.

FIG. 6 is a back view thereof.

FIG. 7 is an end view thereof.

FIG. 8 is an opposite end view thereof.

FIG. 9 is an exploded view of the monitor.

FIG. 10 is a further view showing components of the monitor, their interconnection, and an embodiment of a method of assembling the monitor.

FIG. 11 is another view showing components of the monitor.

FIG. 12 A-C are further views showing components of the monitor.

FIGS. 13 A and B are still further views showing components of the monitor.

FIG. 14 is a diagram showing an embodiment of the functional blocks of the monitor.

FIG. 15 is a schematic diagram of an embodiment of the circuitry of the monitor.

FIG. 16 is another circuit schematic.

FIG. 17 is a flowchart of an embodiment of a magnet programming process for the monitor.

FIG. 18 is a map of an embodiment of the screens for the Portable Diagnostic Unit (PDU) used to configure and monitor the status of the CTM.

FIG. 19 is an embodiment of the PDU startup or logo screen.

FIG. 20 is an embodiment of the List screen.

FIG. 21 is an embodiment of the Menu screen.

FIG. 22 is an embodiment of the Summary screen.

FIG. 23 is an embodiment of the System Configuration screen.

FIG. 24 is an embodiment of the Application Configuration screen.

FIG. 25 is an embodiment of the View Details screen.

FIG. 26 is an embodiment of the View Raw Data screen.

FIG. 27 shows a first step in a method of replacing a battery for the CTM.

FIG. 28 shows more steps in the method of replacing the battery.

### DETAILED DESCRIPTION

### System and Apparatus of the Invention

### I. Introduction

A. System Overview

The cellular communication, monitoring and metering system for fluid storage tanks of the present invention is designed to enhance the efficiency of a bulk liquid distributor's delivery operation. A primary function of the system is to measure and report the liquid level inside of a tank via a Cellular Tank Monitor, (“CTM”) located on or near the tank, which has a cellular link such as a Global System for Mobile Communications (GSM) 2G Cellular link. In addition, the CTM may sense and provide a variety of status, version and configuration information about the tank and its environment. The data gathered by the CTM is sent to a Host Computer System or Unit located at the propane (or other fluid) delivery provider. The provider is typically located far away from the tank, for example within 25 miles of the tank, but it may be any distance away from the tank. Data is sent via the cellular link. The Host is preferably an Independent Technologies, Inc. (Omaha, Nebr. USA) WESROC® RMS Host Computer system. Optionally, the CTM can also send tank level and other data to a Base Unit disposed at a location near the tank, for example at the residence or business premises served by a propane tank. This distance is typically within 100 yards of the tank. A preferred Base is a WESROC® RMS Base Unit and the means of short range communication is preferably via a 900 MHz ISM band radio link. This link is provided for local tank level display purposes at the residence or business.

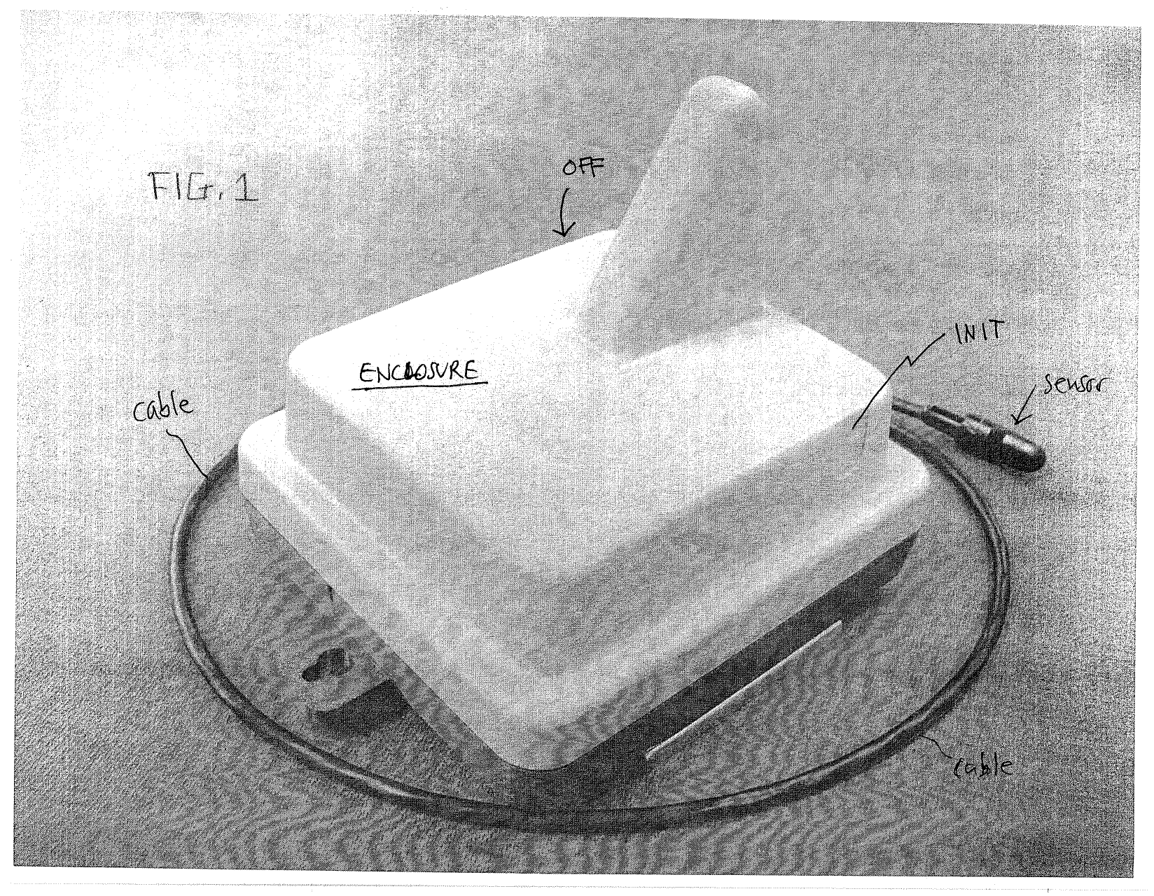

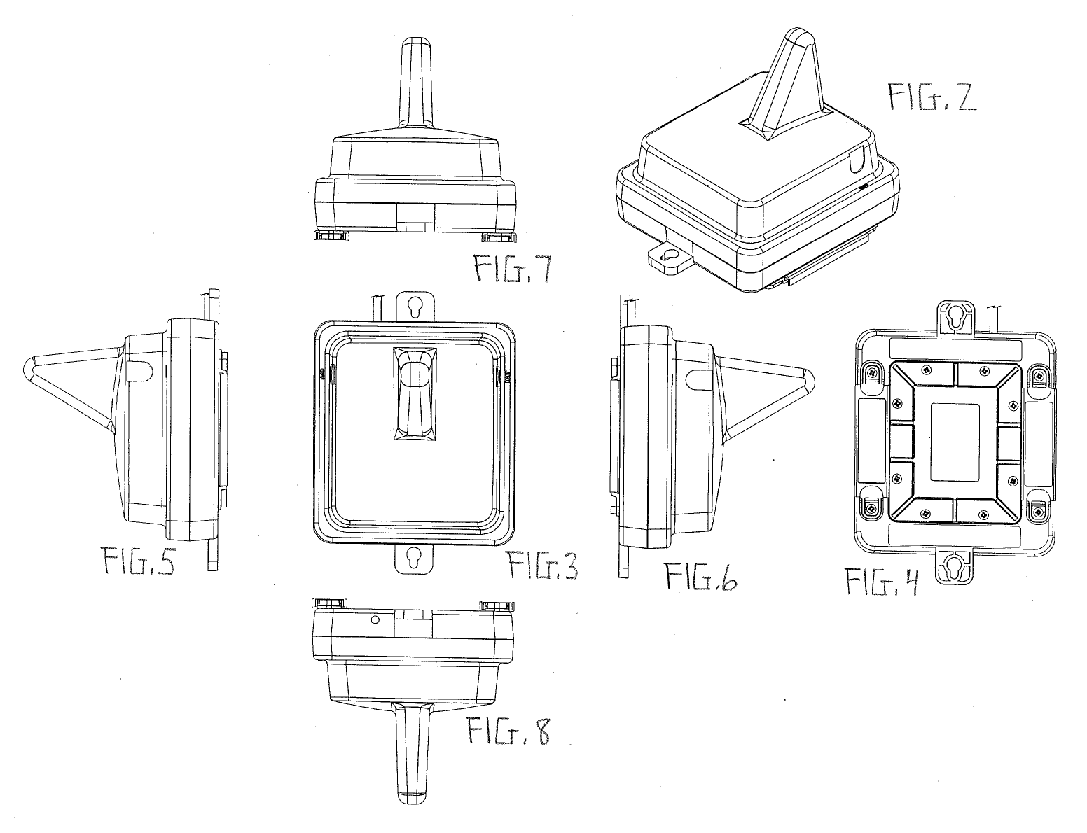

Referring to FIG. 1, The CTM is intended to be installed on the top of a tank and be connected to the sensor ready dial on a standard magnetic liquid level gauge, for example a Rochester Gauge. The CTM senses the position of the gauge and uses this information to calculate the liquid level in the tank.

The CTM can be configured remotely by the Host via the GSM cellular link, or locally using a WESROC RMS Portable Diagnostic Unit (PDU) and the 900 MHz ISM band radio link.

### II. Components

A. Power

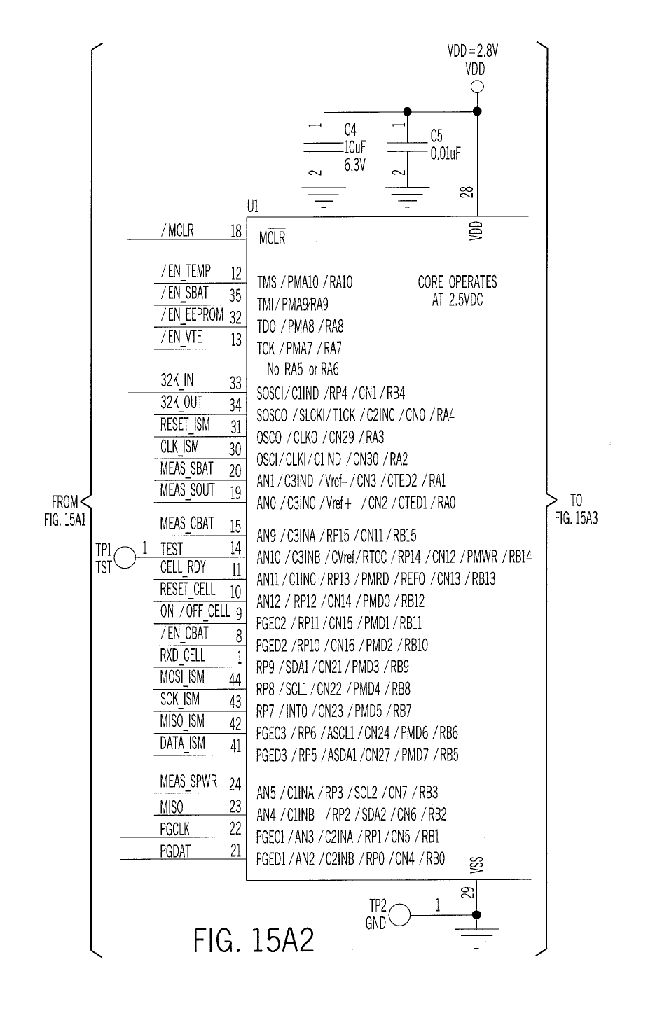

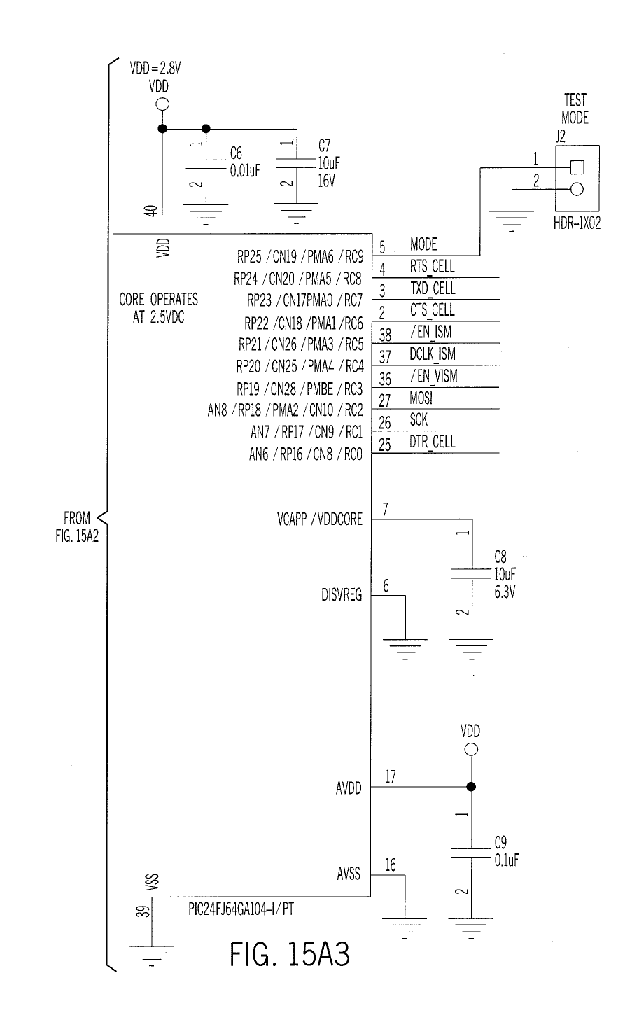

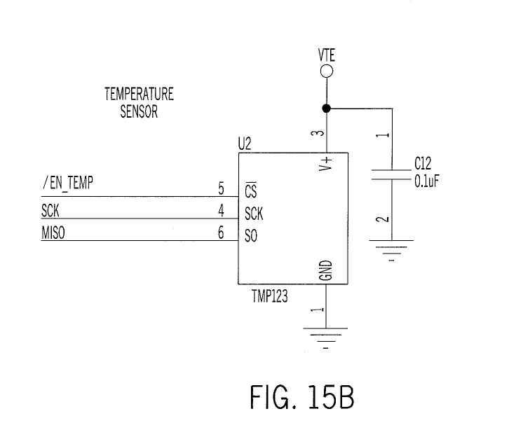

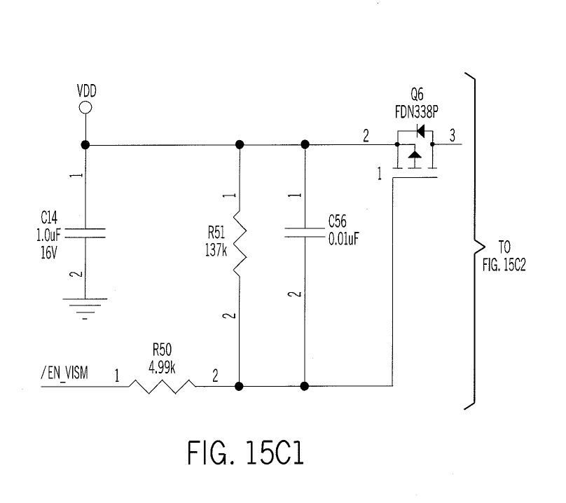

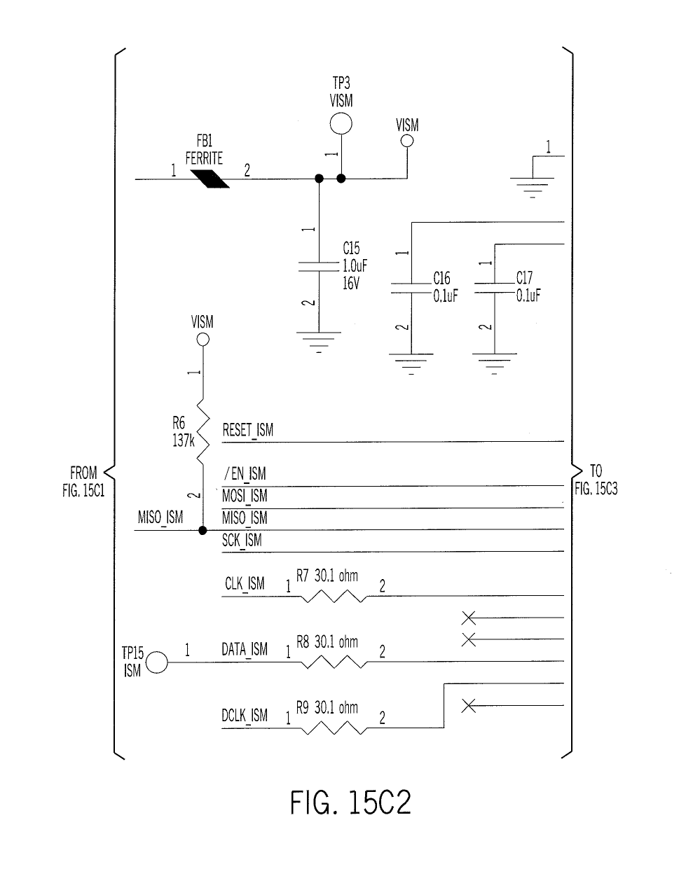

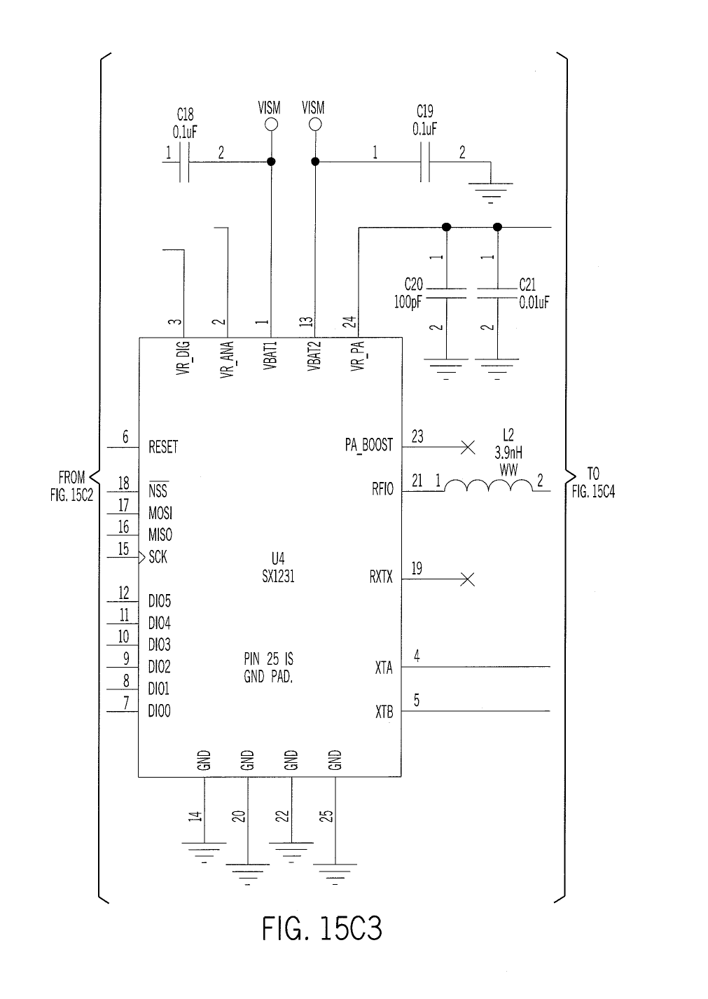

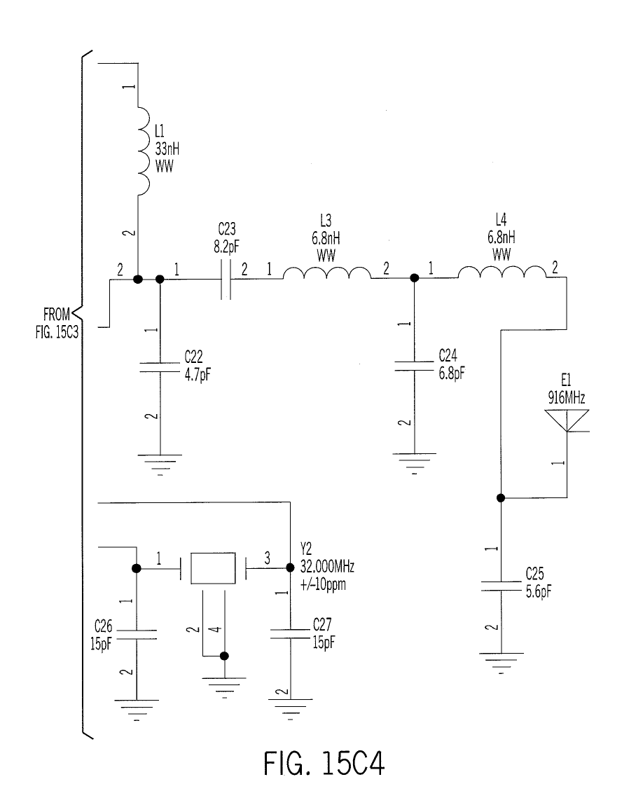

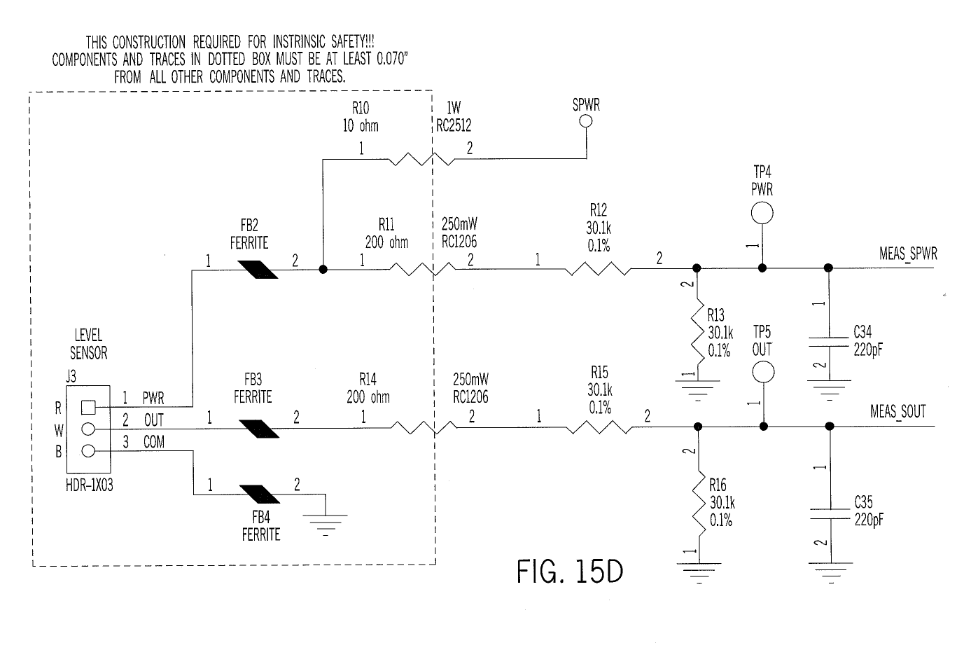

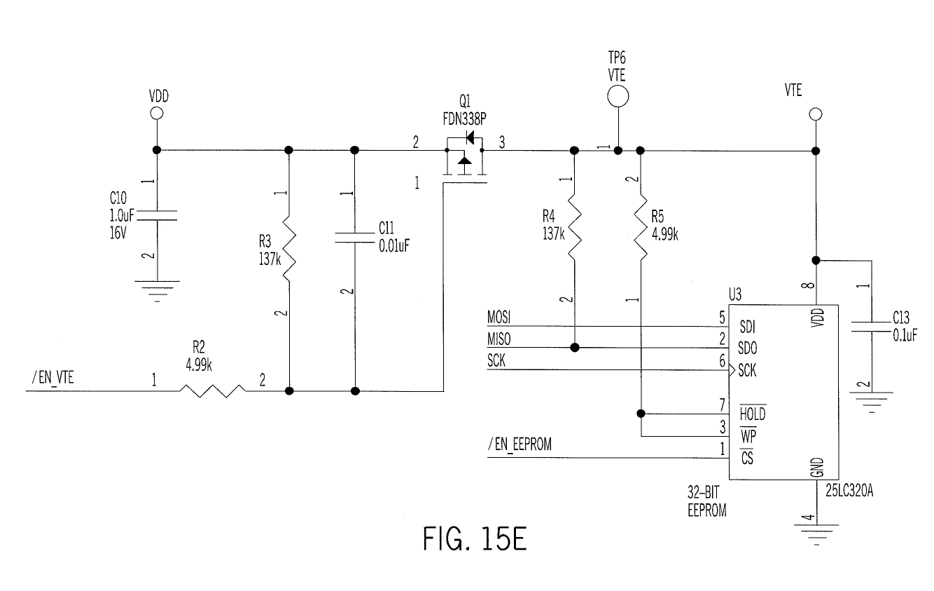

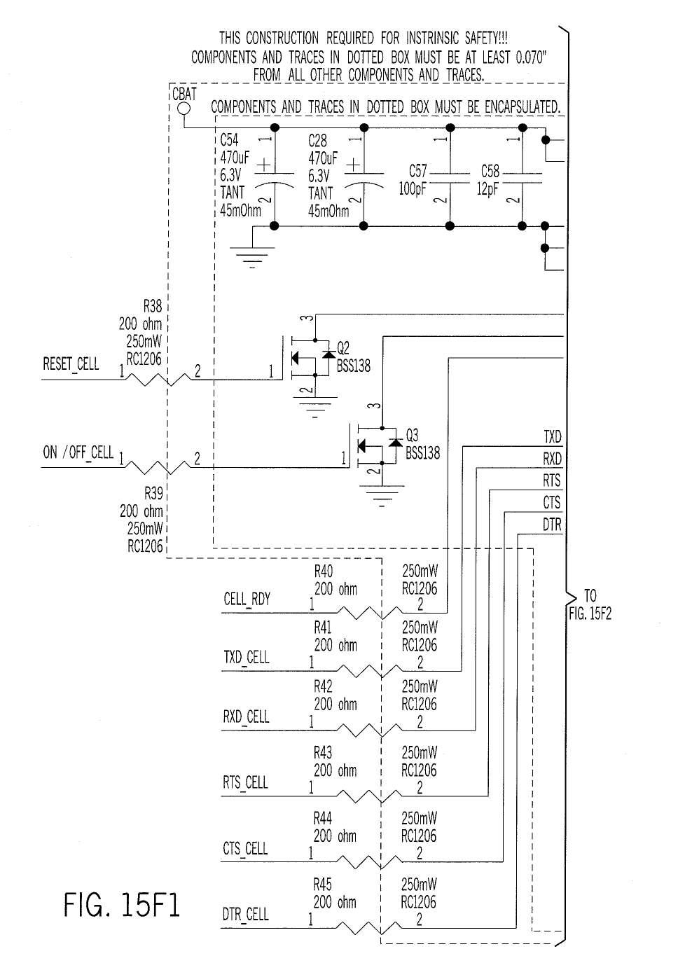

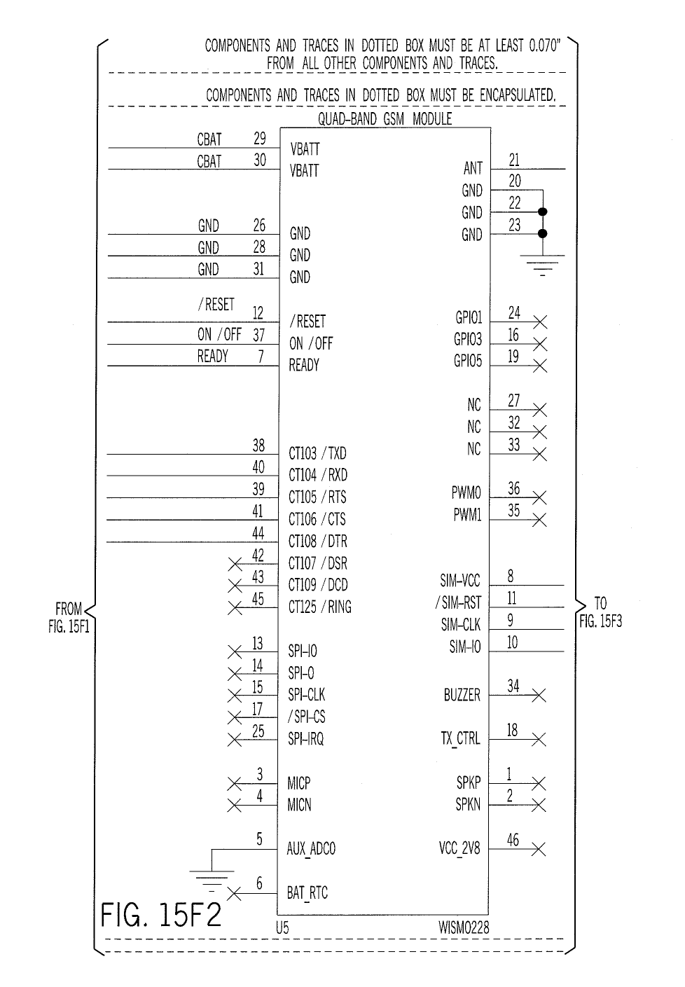

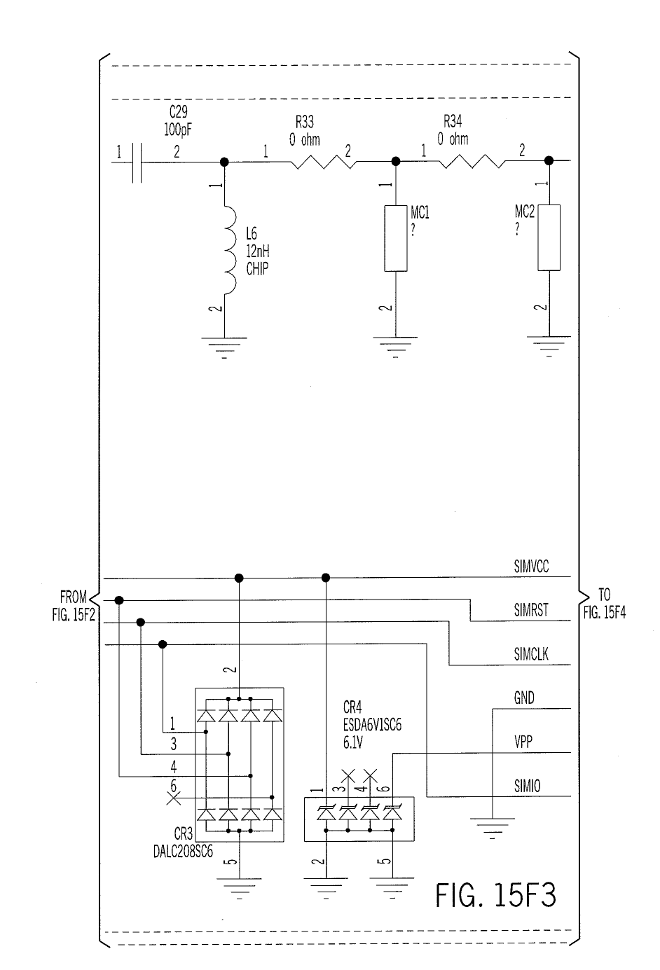

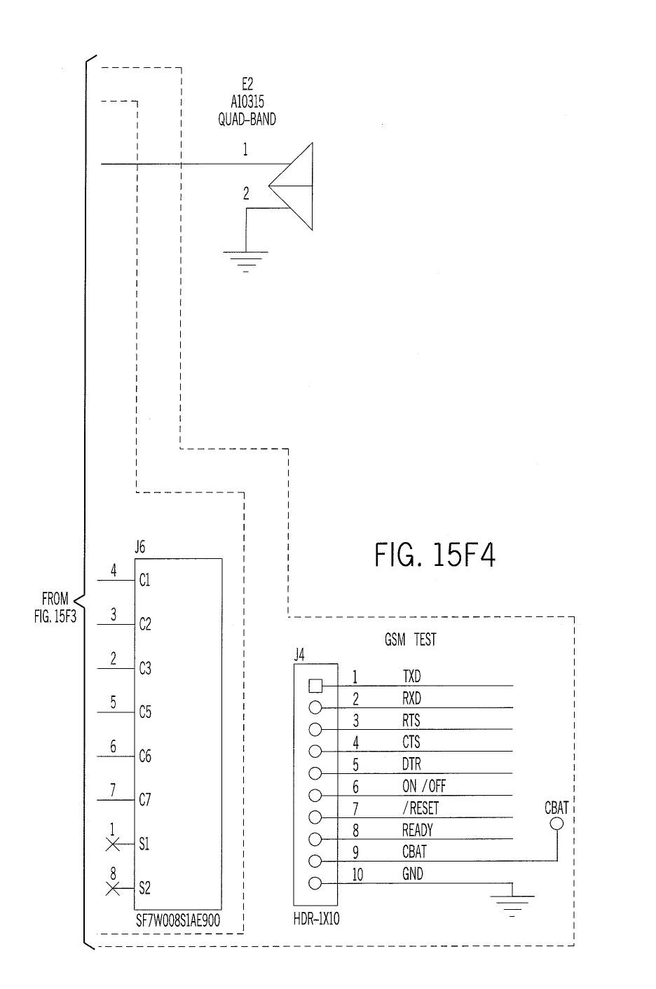

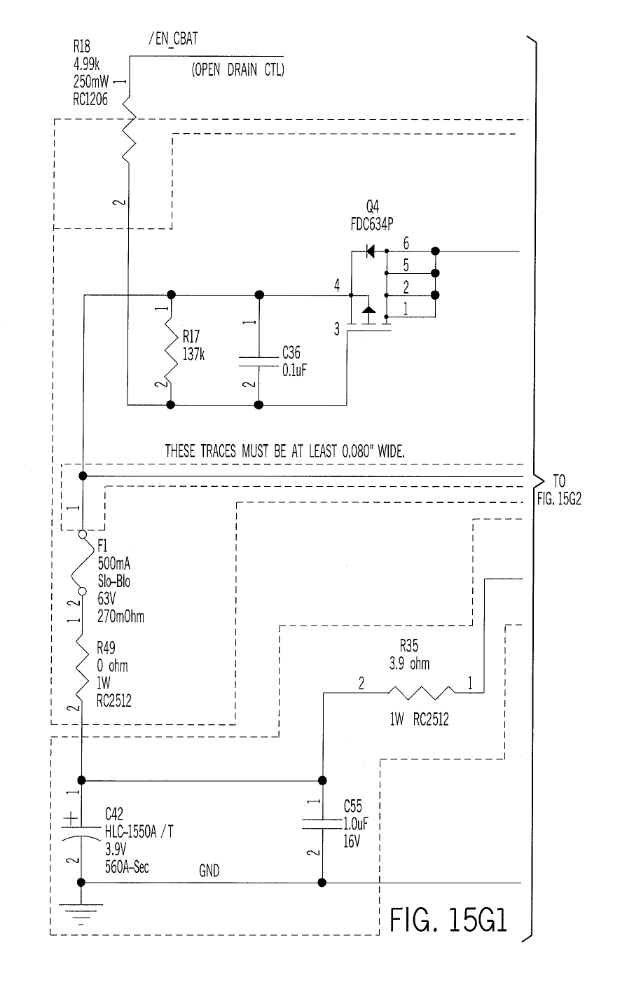

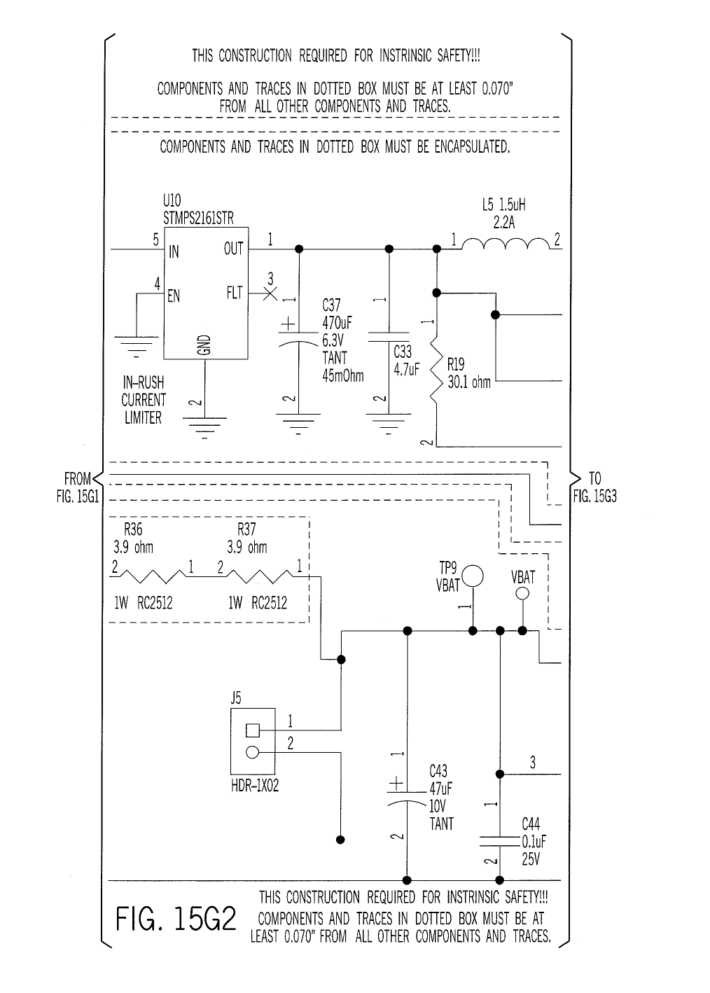

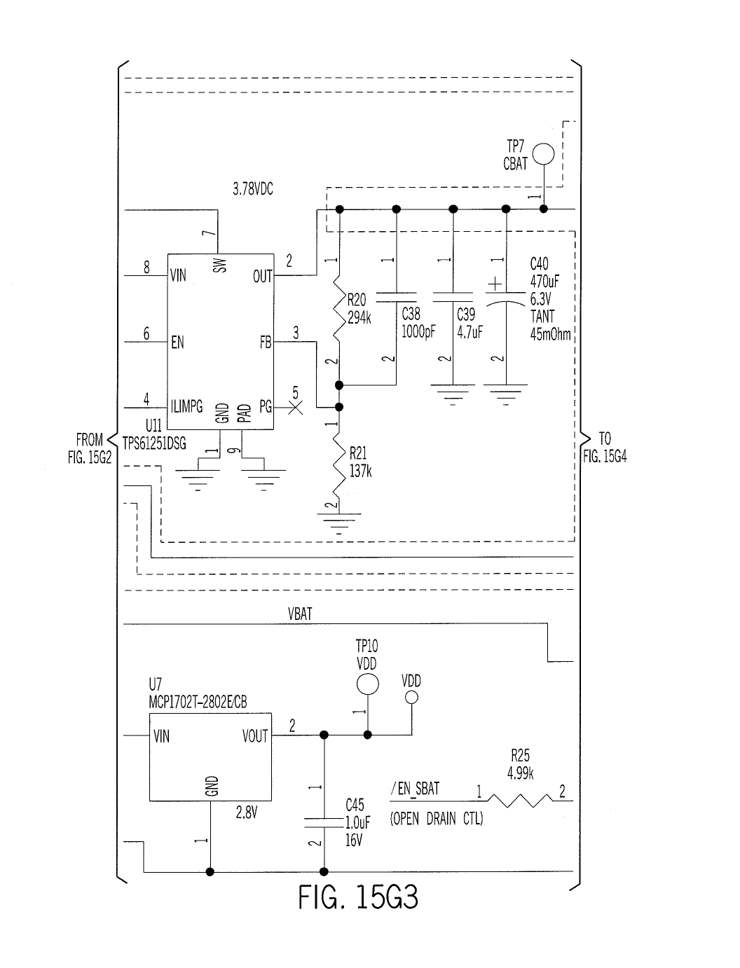

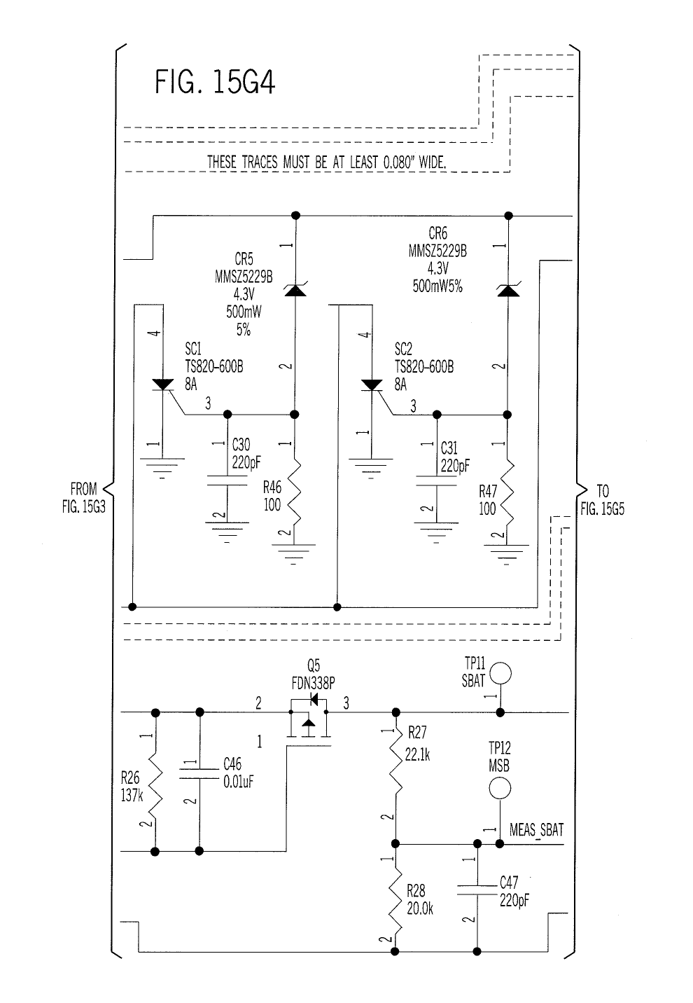

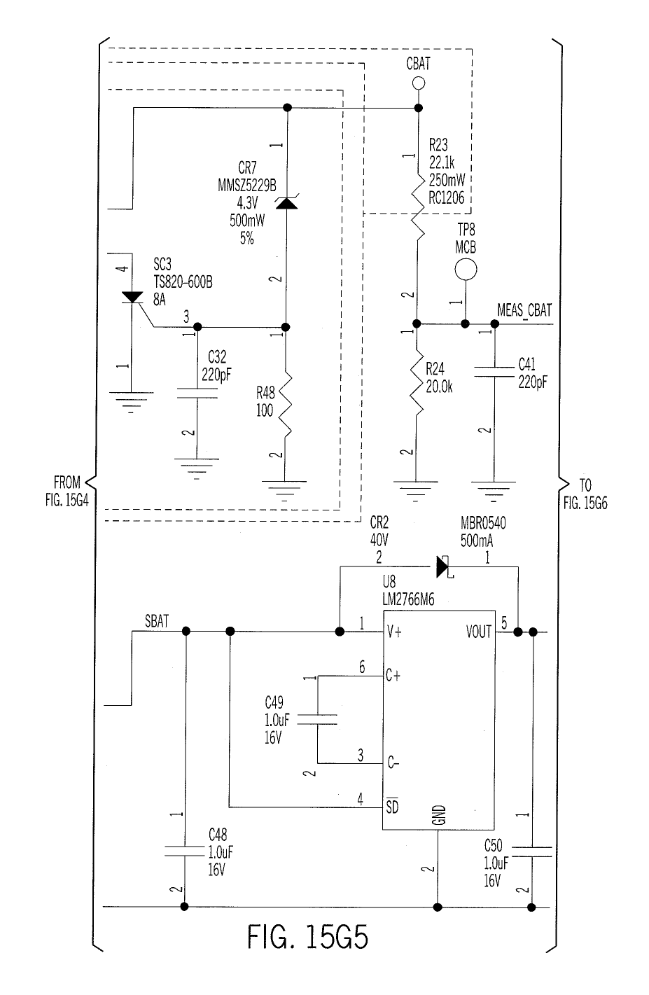

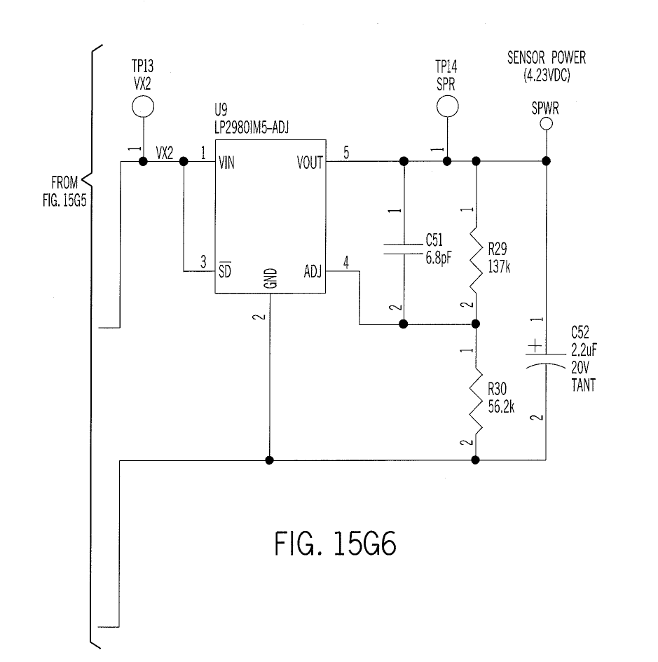

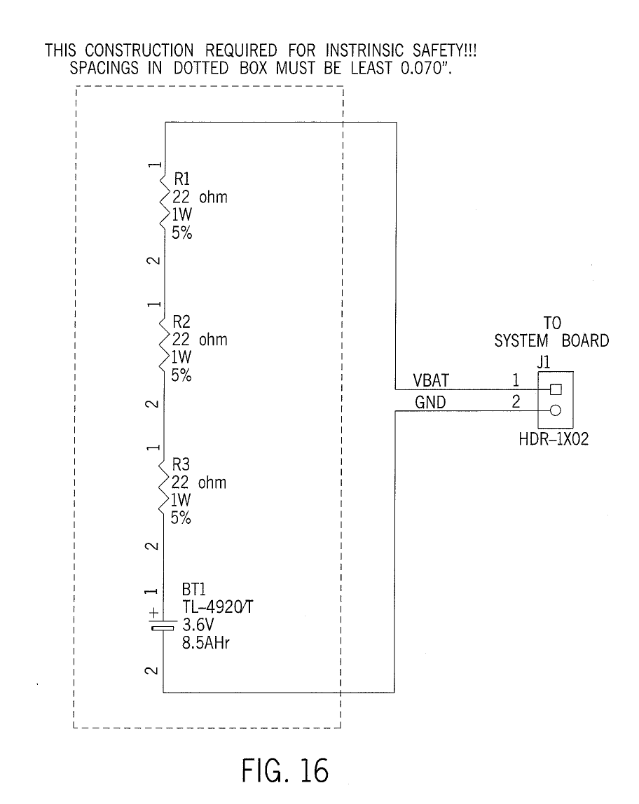

Referring to FIGS. 9, 10, 14 and 15, the CTM uses one 3.6VDC, 8500 mAHr lithium thionyl chloride battery for power.
The battery is contained in a sealed replaceable battery pack.
The battery has tabbed leads and is soldered to the battery pack PCB.
The battery is not rechargeable.
The battery is a UL recognized product.
Protection circuitry limits current from the battery pack to 55 mADC.
The battery feeds power to the system voltage regulator (2.8 VDC) and also trickle charges a hybrid-layer capacitor (HLC).
The HLC is a low impedance 155 mAHr device with tabbed leads that is soldered to the system PCB.
The HLC provides power to a voltage boost converter that provides a steady voltage for the GSM module (3.8 VDC).
Power to the tank level sensor is doubled battery voltage post regulated to 4.23 VDC.
Current to the tank level sensor cable is limited to less than 200 mADC.

B. Microcontroller
The CTM uses a Microchip PIC24FJ64GA104 16-bit microcontroller IC for all control, measurement and communication functions.
Internal FLASH program and SRAM data memories.
Internal 10-bit ADC used for tank level and battery voltage measurements.
Internal SPI busses used to communicate with ISM transceiver control registers, external EEPROM, and system temperature sensor.
Internal UARTs used to communicate with GSM module and ISM transceiver data path.
Internal real time clock with 32.768 kHz crystal oscillator used to time system events.
General purpose I/O used for control and communication.
System clock is an internal 8.00 MHz oscillator or an external 8.00 MHz clock derived from the ISM transceiver.

C. GSM Module

The CTM uses a Sierra Wireless WISMO228 GSM module for communication with the Host. It is a quad-band GSM device that uses the 850 MHz GSM and 1900 MHz PCS bands for operation in the US.
Compact FCC certified SMT module design aids clean performance.
Internal quad-band GSM antenna mounted on system board is connected to GSM module through antenna matching network.
GSM SIM card is mounted next to GSM module on system PCB.
Data communication with Host is via GPRS data session.
Typical total report time duration is 25 to 50 seconds.
GSM module is completely powered down when not being used for GPRS session.
GSM module and associated circuitry is encapsulated to limit maximum surface temperature.

D. 900 MHz ISM Band Transceiver

The CTM uses a Xemics SX1231 RF transceiver IC for short range communication. It has a carrier frequency of 916.48 MHz and uses wideband FSK modulation to send data packets.
Compact SMT RF transceiver circuitry layout assures clean performance.
ISM band transceiver uses a 50-ohm quarter-wave monopole antenna that is permanently soldered to the system PCB.
CTM system PCB provides a RF ground plane that is perpendicular to the antenna.
Data transmissions are at 2400 bps and are about 208 mS in duration.
ISM transceiver is completely powered down when not in use.

E. External EEPROM

The CTM uses a Microchip 25LC320A serial EEPROM IC for storage of system configuration information.
The EEPROM is read at power on, and is written to after every report, and after every configuration change.
The EEPROM IC is completely powered down when not in use.

F. Temperature Sensor

The CTM uses a Texas Instruments TMP123 digital temperature sensor IC to measure on-board temperature.”
Digital temperature sensor ensures accurate and repeatable measurement.
Temperature is measured right before every GSM report and ISM band transmission.
The temperature sensor IC is completely powered down when not in use.

G. Level Sensor Interface

The CTM uses a hall-effect sensor to track the rotational position of the magnet in the dial mounted to a liquid level gauge head. The sensor is mounted at the end of a cable that can be ordered in different lengths and is reflected in the following options.
Sensor is connected to Transmitter by a 22AWG, 3-conductor, PVC jacketed cable.
   Option S3 uses a straight sensor and 3′ long sensor cable.
   Option S10 uses a straight sensor and 10′ long sensor cable.
   Option S30 uses a straight sensor and 30′ long sensor cable.
   Option R3 uses a right-angle sensor and 3′ long sensor cable.
   Option R10 uses a right-angle sensor and 10′ long sensor cable.
   Option R30 uses a right-angle sensor and 30′ long sensor cable.
   Option U3 uses an in-line connector and 3′ long sensor cable.
      (As is best shown in FIG. 1, the cable for Option U3 is typically connected to another 10′ long cable having an in-line connector on one end, and a hall-effect sensor on the other.)
Voltage to sensor is regulated to 4.23 VDC, current is limited to less than 200 mADC.
Hall-effect sensor is powered on for 8 mS once every minute.
Capacitance at sensor interface is 2.2 uf.

H. Enclosure

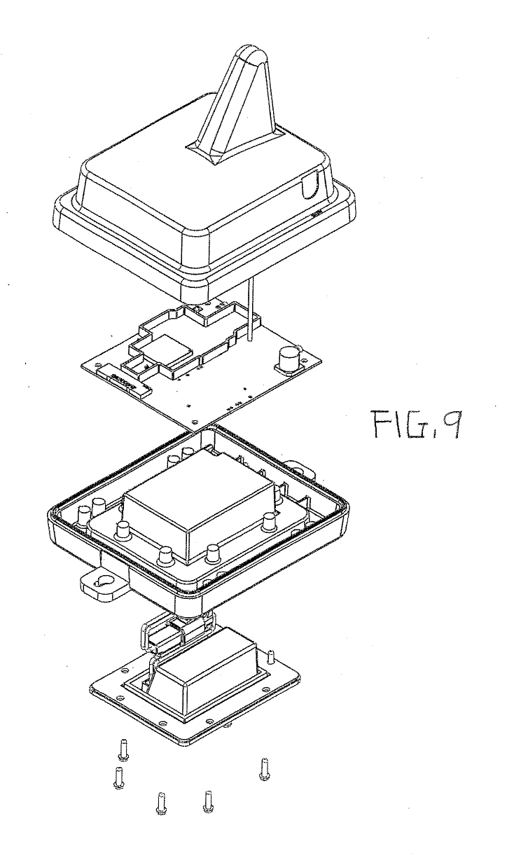

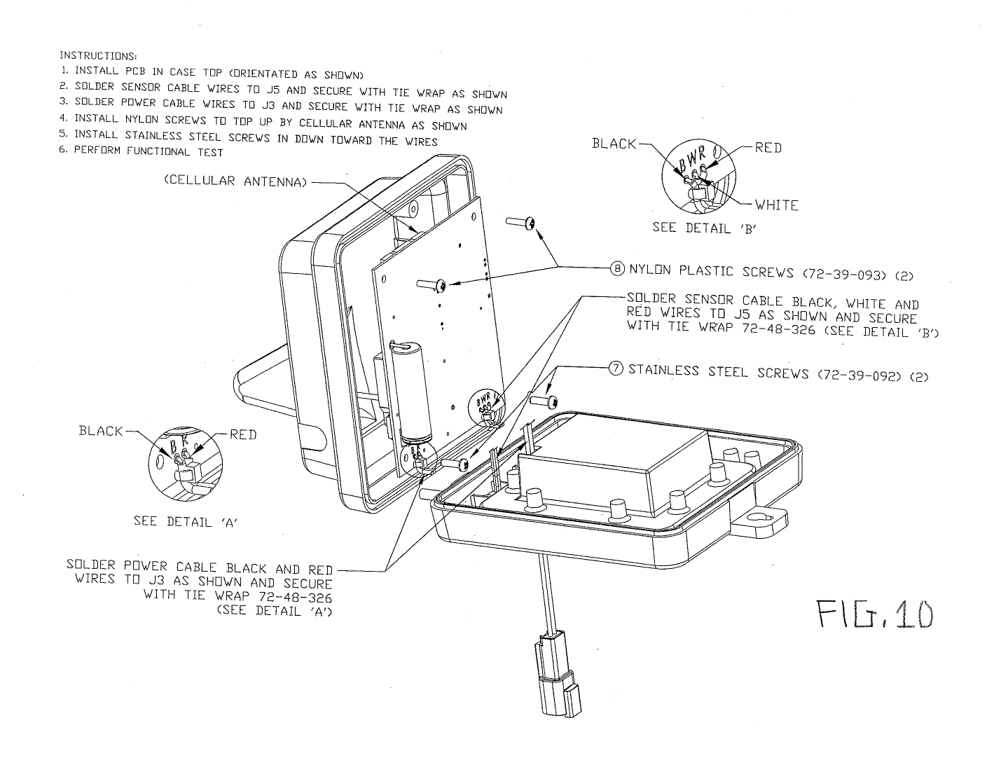

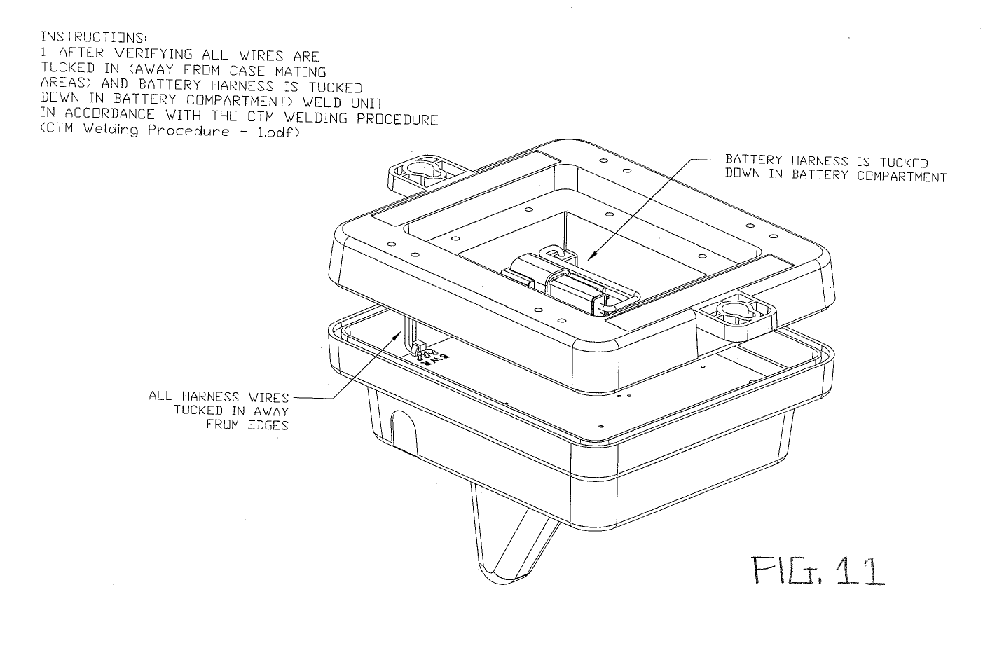

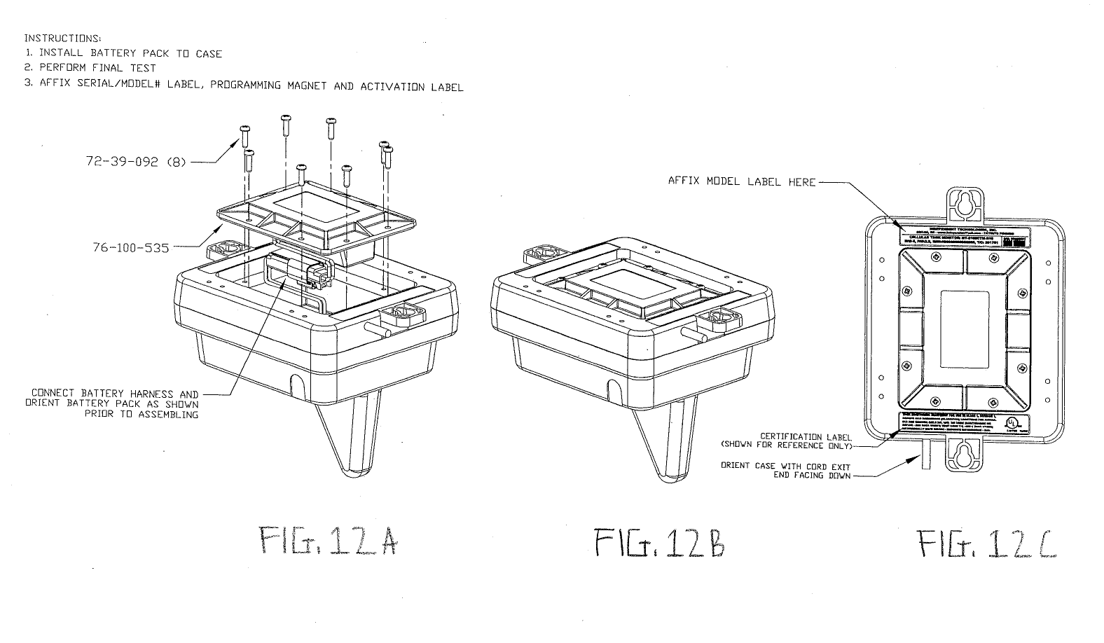

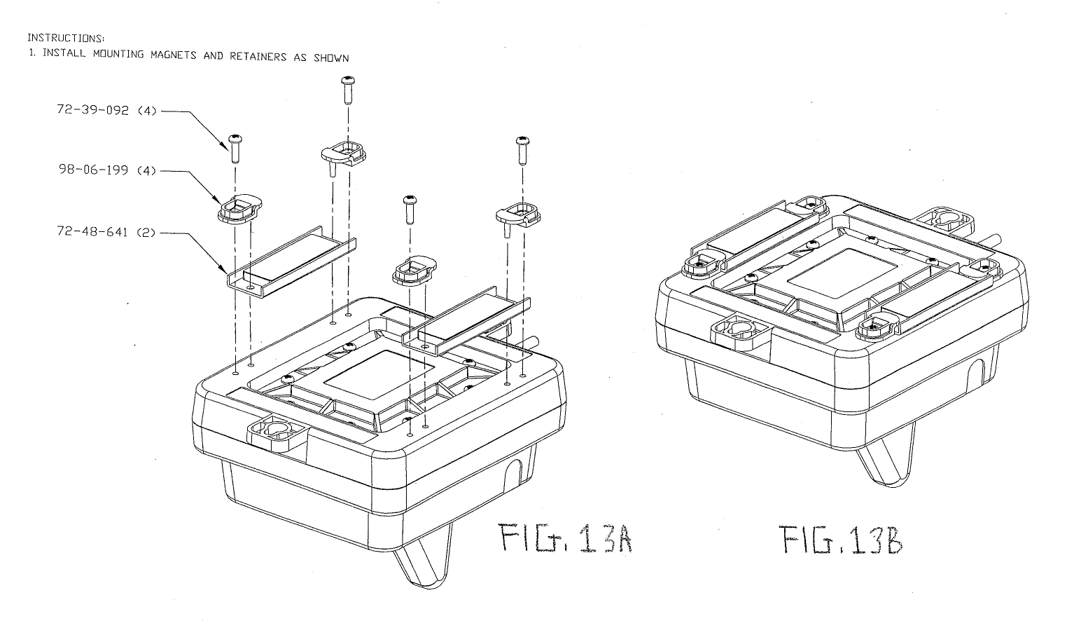

Referring to FIGS. 1-13, the CTM is housed in a rugged, weather-tight enclosure.
Enclosure is molded from a UV stabilized high-impact polystyrene material.
Enclosure is ultrasonically welded to completely waterproof interior compartment.
Intrinsic safety and RF compatibility information is printed on enclosure labeling.
Enclosure is mounted with two non-sparking channel magnets rated at 22 lbs. of pull each, or can optionally be mounted with a right-angle mounting bracket.

I. Block Diagram

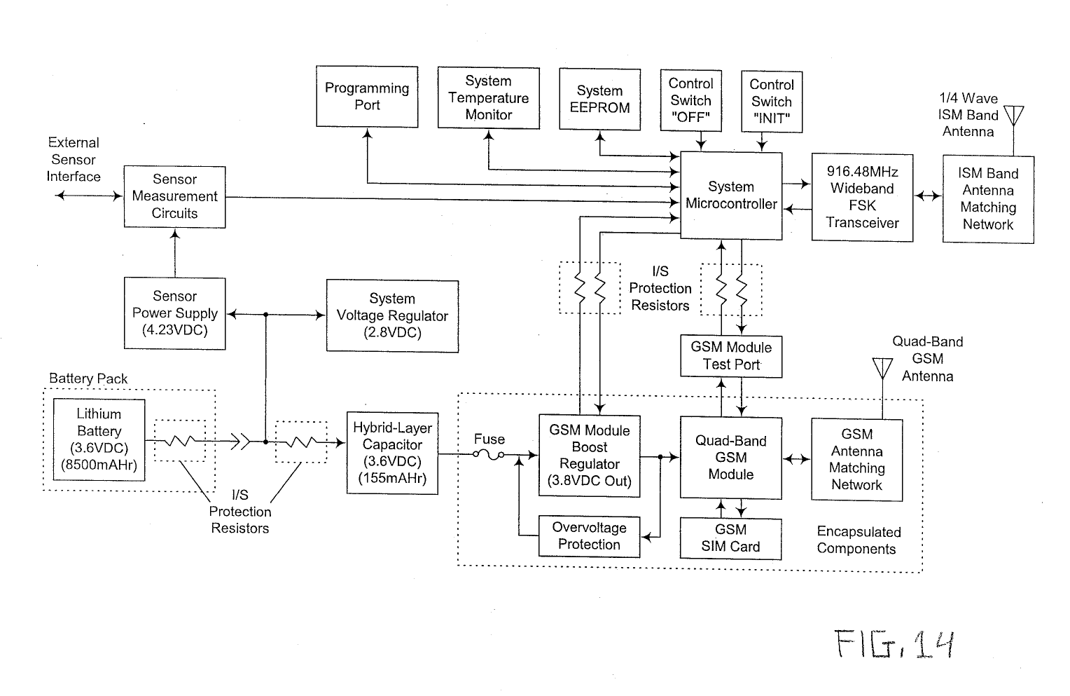

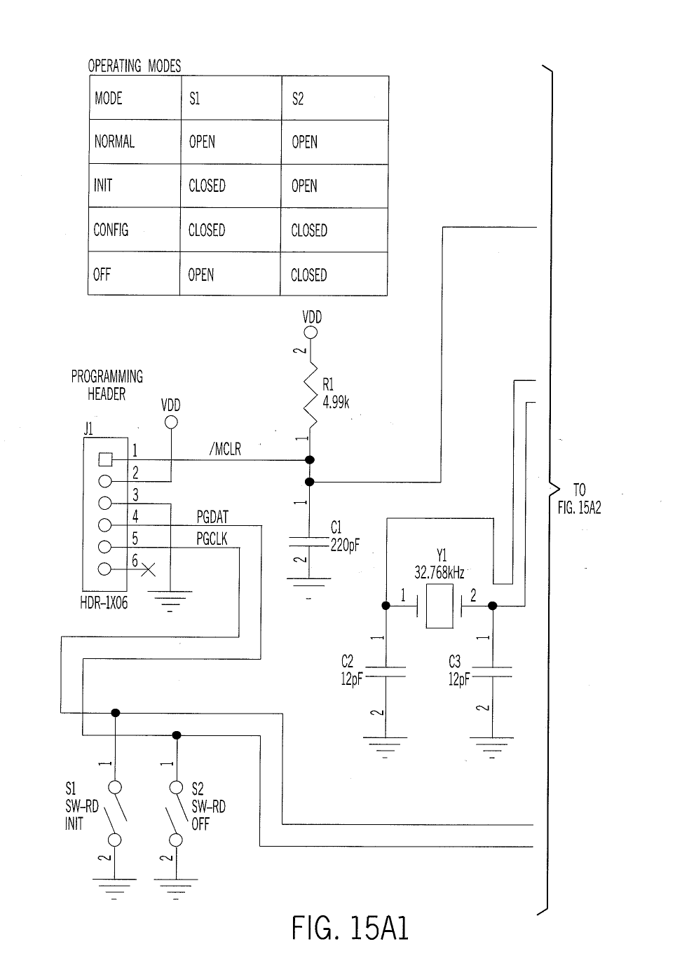

Referring to FIG. 14, a preferred embodiment of the functional blocks of the CTM are shown.
System Microcontroller Clocks:
   8.00 MHz internal oscillator. (Off when sleeping.)
   32.768 kHz external crystal oscillator. (On continuously.)
916.48 MHz ISM Band FSK Transceiver Clock:
   32.00 MHz external crystal oscillator. (Only on when ISM radio is powered up.)
GSM Module Clocks:
   Unknown. (Only on when GSM module is powered up.)
   32.768 kHz external crystal oscillator. (Only on when GSM module is powered up.)

### III. Operation

A. Basic Functionality

When configured for normal operation, the CTM spends most of its time in a low power sleep mode. Once per minute, the CTM will wake up and measure the tank level sensor, internal battery voltage, and temperature sensor. If a tank level event has occurred or if its time for a scheduled report, the CTM will power up the GSM module and will report to the host via a GPRS data session. Communication with the Host is always originated by the CTM.

The ISM band radio transceiver is used for communicating with the handheld PDU at installation time. Optionally, it can be used to send tank level data to a WESROC RMS Base Unit for local tank level display purposes. The ISM band radio transceiver and GSM module are never powered up and in operation at the same time.

B. GPRS Data Packets

The CTM uses the GSM/GPRS network to send UDP packets over the internet. The CTM will send one of the following data packets depending on the situation.
Configuration Packet (200 bytes).
Standard Packet (106 bytes).
Ack Packet (29 bytes).
Nack Packet 29 bytes).
   The Host will respond with one of the following data packets depending on the situation.
Configuration Packet (74 bytes).
Standard Packet (31 bytes).
Ack Packet (27 bytes).
Nack Packet 27 bytes).

C. ISM Data Packets

The CTM uses a 900 MHz ISM band radio transceiver to send and receive data packets at 2400 bps. The CTM will send one of the following ISM data packets depending on the situation.
Configuration packet. (194 bytes plus overhead).
Standard tank transmitter packet. (28 bytes plus overhead).

D. External Control

The CTM has four basic operating modes. These modes are selected by placing programming magnet(s) in marked recesses on the outside of the CTM enclosure to activate internal reed switches.

### OFF Mode: (One Magnet in OFF Position)

Default mode when CTM is not in use.
CTM is in a low power sleep state.
CTM wakes up once every second to check state of reed switches.

### INITIALIZATION Mode: (One Magnet in INIT Position)

Initialization mode is used to register the CTM to a WESROC RMS Base Unit.
Initialization mode is also used for CTM demonstration purposes.
CTM checks state of reed switches and tank level once every second.
CTM sends ISM data packet every 15 seconds or immediately if tank level changes.
After 60 minutes, the CTM times out and switches to NORMAL mode.

### NORMAL Mode: (No Magnet in Either Position)

Normal operating mode as installed in field.
CTM checks state of reed switches once every second.
CTM measures tank level once per minute.
If configured for local display, the CTM will send an ISM data packet every four hours or immediately if the tank level changes.
The CTM will report to the Host if any tank level events occur, or if its time for a scheduled report.

### CONFIGURATION Mode: (One Magnet in Both OFF and INIT Positions)

CTM checks state of reed switches once every second.
When entering this mode, the CTM will send an ISM configuration packet and will then wait for an ISM command packet from a PDU.
When an ISM command packet is received from a PDU, the CTM will respond with an ISM configuration or message packet to update the PDU display.
The CTM will perform a GPRS configuration report to the Host when the CTM is returned to Normal or Off mode. This is done to synchronize the CTM configuration with the Host configuration.
The CTM will time out of Configuration mode and return to Normal mode if it has not received an ISM command packet for 15 minutes.

E. Event Handling

In addition to reporting normal tank level measurements, the CTM will qualify a number of special tank level and system events and will send data related to those events.

i. Tank Fill Event
The CTM closely monitors increases in tank level. When an increase occurs, the CTM begins looking for further increases. If no further increases are detected within a specified period of time, the tank level increase is compared to the configured tank fill threshold. If the tank level increase is greater than the threshold, the CTM reports the fill event to the Host.

ii. Tank Draw Event
If the CTM measures a decrease in tank level of at least the configured tank draw threshold within one hour, it will consider it a tank draw event and will report the event to the Host.

iii. Tank Warn Low Level Condition
If the CTM measures a tank level of less than the configured warning low threshold, the CTM will consider the tank level to be low and will report the condition to the Host.

iv. Tank Critical Low Level Condition
If the CTM measures a tank level of less than the configured critical low threshold, the CTM will consider the tank level to be critically low and will report the condition to the Host.

v. Tank Warn High Level Condition
If the CTM measures a tank level of greater than the configured warning high threshold, the CTM will consider the tank level to be high and will report the condition to the Host.

vi. Tank Critical High Level Condition
If the CTM measures a tank level of greater than the configured critical high threshold, the CTM will consider the tank to be critically high and will report the condition to the Host.

vii. Tank Level Change Event
If the CTM measures a tank level that has changed since the last report to the Host by an amount greater than the configured percent change threshold, the CTM will consider the tank to have changed enough to trigger a report of the event to the Host.

viii. Lost Sensor
If the CTM has measured a tank level of 0% for at least 15 minutes, it will set the lost-sensor status flag in the GPRS and ISM data packets. This flag will be set in all subsequent reports and transmissions for as long as the condition is true.

ix. Low Battery
If the CTM has measured a system battery voltage below the configured low battery threshold, it will set the low battery status flag in the GPRS and ISM data packets. This flag will be set in all subsequent reports and transmissions for as long as the condition is true.

### IV. Summary of Specifications of Preferred Embodiment

Mechanical

### Size: 7.6″L×5.3″W×5.6″H

### Weight: Approximately 1.5 lbs.

Mounting: Dual channel magnet or right-angle bracket.

Power Source

Model: MT-9100BPK-02 (Available from Independent Technologies)
Type: Field replaceable, sealed and intrinsically safe battery pack.

### Voltage: 3.6 VDC

Expected Life Greater than 5 years (reporting once per day).

Environment

### Temperature: −40 C to +60 C

Tank Level Sensor

### Sensor Type: Rochester R3D Hall-Effect or In-Line Connector

Cable Length: 3 foot or 10 foot depending on model

Cellular Radio

### Type: GSM Quad-Band Cellular Module

### Bands: GSM850, EGSM900, DCS1800, PCS1900

### Antenna: Internal

### FCC ID: N7NWISMO228

### IC: 2417C-WISMO228

ISM Radio

### Type: US 900 MHz ISM Band FSK Transceiver

### Frequency: 916.48 MHz

### Power: +8 dBm (6.3 mW) max

### Antenna: Internal

### THE METHOD OF USE OF THE INVENTION

I. Overview of Use

A. Device Characteristics

The WESROC® RMS Cellular Tank Monitor (CTM) is used to remotely monitor the level of the contents of a tank. The tank level and additional event and status information are reported to the WESROC® RMS Host System (Host) at scheduled intervals. In addition, the CTM will report to the Host immediately to track tank events in real time. The CTM uses the GSM/GPRS cellular network and the internet to transport this information.

Communication with the Host is always originated by the CTM, but is bi-directional once a GPRS data session has been established. This allows for remote configuration of the CTM should the tank monitoring requirements change or in the event that the CTM is moved to another site.

The CTM also provides a local tank level display capability. The CTM can be configured to send ISM radio data packets to a nearby WESROC® RMS Base Unit (Base Unit). Once initialized to the CTM, the Base Unit will provide the customer with a local display of tank level for up to eight tanks (depending on which Base Unit is used).

B. Installation

A basic CTM installation is easily performed in a few minutes by persons with a basic understanding of the tank equipment to be monitored and of the CTM device itself. Since the CTM is self-contained, the complete installation can be performed at the tank. No access to the customer's residence or place of business is required when local tank level display is not needed.

By default, the CTM is configured to monitor the most common type of tanks, but may be re-configured to monitor a wide variety of tank configurations. The CTM may be remotely configured by the Host, or may be configured on site by using the handheld WESROC® RMS Portable Diagnostic Unit (PDU).

C. Power

The CTM is battery powered, and due to its low power design will provide many years of remote monitoring before battery pack replacement is required. Battery pack replacement may be performed at the tank as the CTM and battery pack are both designed and certified to be intrinsically safe for use in hazardous environments.

II. Installation

A. Mounting Location

The WESROC® RMS Cellular Tank Monitor (CTM) is designed to be installed directly on the tank to be monitored. The CTM is connected to the tank gauge by the tank level sensor and sensor cable. The CTM itself may be attached to the tank with the supplied mounting magnets or with a mounting bracket. The CTM may also be located a few feet away from the tank if necessary to improve cellular reception. Versions of the CTM are available with a longer sensor cable to facilitate mounting the CTM further away from the tank.

B. Tank Gauge

The standard CTM is equipped with a hall-effect based tank level sensor. This sensor is designed to be snapped into a remote ready tank gauge dial. The sensor and dial are part of the R3D dial and sensor system manufactured by Rochester Gauges. R3D dials are available for a wide variety of tank and gauge types. The CTM is configurable to work correctly with all available types. In addition, a version of the CTM is available that has an in-line connector at the end of sensor cable. This enables the CTM to work on large bulk tanks with large remote ready dials using the standard sensor manufactured by Rochester Gauges, or the newer Precision Large Dial Sensor manufactured by Independent Technologies, Inc.

C. Cellular Signal

The CTM must be installed in a location served by GSM based cellular service. GSM is a very widely deployed type of digital cellular service—two of the largest service providers are AT&T and T-Mobile. The CTM is supported by both of those major carriers and by a large number of other smaller regional GSM service providers.

The CTM has a robust cellular sub-system, but there are limits to the capabilities of the cellular network in general. As with most wireless technologies, cellular signal reception can be affected by obstructions such trees, mountainous terrain, buildings, metal structures, large vehicles parked nearby, etc. In addition, cellular signal reception will be directly affected by the distance between the CTM and the nearest cell tower with GSM service.

The best signal reception will be achieved with a line of sight path between the CTM and the cell tower. Obviously, this is rarely the case in the real world, but it should be kept in mind when selecting a mounting location for the CTM. Elevation can also help; typically performance will increase as the CTM is raised higher above the ground. The orientation of the CTM itself will also affect performance. The CTM should be installed upright, and if possible, with the sensor cable exit from the CTM enclosure pointed AWAY from the nearest cell tower supporting GSM service.

D. Host Information

The customer information, installation location, and tank configuration for the installation site must be entered into the WESROC® RMS Host System (Host) BEFORE the CTM is installed on the tank. A CTM Installation Information Worksheet outlining the required information is included in the box and is also available from your host administrator or from Independent Technologies, Inc. Email or fax the completed worksheet to the host administrator before beginning the installation. Installation information can also be called in verbally provided your host administrator considers this an acceptable method.

E. Installation Steps

Performing the installation steps in the order shown will help ensure proper operation of the CTM. A large percentage of “trouble sites” are caused by improper installation.

1) If possible, perform a site visit to the location of the tank to be monitored. Determine the size of the tank and the type of gauge on the tank. This will help you select the right equipment to bring with at installation time. This is also a good time to try to determine if you have GSM cellular service available. Access to a GSM cell phone can help with checking for the presence of a usable GSM cellular signal.

2) Send a completed CTM Installation Information Worksheet to your host administrator. Try to do this at least one day BEFORE you intend to perform the actual installation so that the host administrator has time to enter the information into the Host.

3) If not already done, install the correct remote ready dial or large dial assembly on the tank gauge. This step is covered in more detail in the WESROC® RMS Dial Replacement Guide available from Independent Technologies, Inc.

4) Remove the CTM from the box and make sure it has the right type of sensor and sensor cable for your application. Make sure the small round programming magnet is secured in the OFF position on the CTM enclosure. This is important to ensure proper operation of the CTM when you are ready to perform the first report to the Host.

5) Mount the CTM directly on or near the tank to be monitored. The maximum distance from the tank will be determined by the length of the sensor cable on the particular type of CTM that you are using. The CTM may be mounted to the steel surface of the tank using the mounting magnets on the bottom of the CTM. Another option is to mount the CTM to a pole or another nearby structure using a right-angle mounting bracket. Mounting brackets can be obtained from Independent Technologies, Inc.

Try not to place the CTM right next to a vertical metal object such as a tank dome or hood. Metal objects higher than the bottom of the CTM enclosure tend to have a negative effect on cellular signal quality. As mentioned before, the CTM should be installed upright, and if possible, with the sensor cable exit from the CTM enclosure pointed AWAY from the nearest cell tower supporting GSM service.

6) Connect the sensor at the end of the sensor cable to the remote ready dial. This is accomplished by sliding the sensor into the sensor slot on the top of the dial. Slide the sensor from the side towards the center of the dial until it is fully seated. You will hear or feel a small “snap” once it is fully seated. To remove the sensor from the dial, gently lift up on the end of the sensor before attempting to slide it out of the dial.

Large dial installations use an in-line connector to attach the CTM to the dial. When attaching an in-line connector, make sure the connector is fully seated and that the locking ring has been fully turned to ensure a weather tight seal.

7) (Optional.) If you are going to be using a WESROC® RMS Base Unit (Base Unit) as a local display device, now is the time to initialize the CMT to the Base Unit. See section “Operation” of this document for details. The “Local Display” system configuration parameter on the CTM must be enabled for this feature to work.

8) This step assumes that the installation site information has already been entered into the Host and that this particular installation does not require any unusual configuration of the CTM. Remove the programming magnet from the OFF position on the CTM enclosure and step away from the CTM. (Do not degrade the CTM cellular signal quality by leaning over it while it is attempting to report.)

At this time, the CTM will attempt a configuration report to the Host. The report is typically completed in 30 to 40 seconds, but can take up to 3 minutes to complete under adverse cellular signal conditions.

The CTM does not provide any direct feedback regarding report success or failure; therefore it is highly recommended to make use of a handheld WESROC® RMS Portable Diagnostic Unit (PDU) when performing CTM installations. The PDU will provide the installer with a wealth of information regarding report status, tank level status, CTM system status, and cellular network performance. See section “Portable Diagnostic Unit” of this document, or the WESROC® RMS Portable Diagnostic Unit Operation Manual for more information on operating the PDU.

Another option for checking report status is to have the Host send a text alert message to the installer's cell phone once a successful report has completed. This of course requires that the host administrator enter the installer's texting address into the Host before installation time. Once installation is completed, the installer will want to have their texting address taken off of the alert list for this site to prevent the Host from sending the installer future tank activity alerts.

9) Once a successful report has completed, secure the sensor cable using appropriate fasteners (cable ties, etc.). Route the sensor cable to make sure the cable will not be damaged by a moving object such as a tank dome or hood. Before leaving the installation site, make sure any programming magnets are removed from the CTM enclosure. Normal operating mode is with NO programming magnets installed.

III. Operation

A. General

After the WESROC® RMS Cellular Tank Monitor (CTM) has been installed on the tank to be monitored; it will periodically report tank level and activity data, and system status information to the WESROC® RMS Host System (Host). Reports can be triggered by expiration of a scheduled report interval timer, or by tank level events or conditions.

B. Operating Modes

The CTM has four basic operating modes, only one of which is used during normal operation. The other three modes are used for installation, configuration, or storage purposes. The four modes are selected by the installer using one or two small round programming magnets. The magnets are placed in the programming magnet recesses on the sides of the CTM enclosure when selecting different operating modes. FIG. 17 is a flow chart of programming magnet use. One programming magnet is supplied with each CTM. It is recommended to keep a few extra magnets on hand for use when configuring a CTM.

### OFF Mode: (One Programming Magnet in OFF Position.)

Off mode is used for storage of the CTM. This is the mode the CTM will be in when shipped from the factory. When in Off mode, the CTM will wake up once per second and check the position of the programming magnets. If the installer has moved the programming magnet position(s) the CTM will switch to the newly selected mode. If not, the CTM will resume sleeping for another second. Always leave the CTM in the Off mode to minimize battery drain and to minimize cellular data charges when a CTM is not in use.

### NORMAL Mode: (No Programming Magnets.)

Normal mode is used while the CTM is monitoring the level of the tank. This is the default operating mode of the CTM once it has been installed. While in this mode, the CTM will wake up once per minute and measure the level of the tank contents. The CTM will then go back to sleep or will take the appropriate action if the tank level has changed since the last measurement. Actions may include starting or ending the qualification of a tank level event, reporting a tank level event to the Host, or reporting to the Host at a scheduled report time. While in Normal mode, the CTM is also constantly monitoring itself for any conditions that may require reporting to the Host. The CTM will also simulate a WESROC® RMS Tank Transmitter and will send ISM radio data packets to a Base Unit while in this mode if the “Local Display” system configuration parameter has been enabled.

### INITIALIZATION Mode: (One Programming Magnet in INIT Position.)

Initialization mode is used for initializing the CTM to a WESROC® RMS Base Unit (Base Unit) before using the Base Unit as a local tank level display device. Once the CTM has been put into Initialization mode, it will simulate a WESROC® RMS Tank Transmitter and will send an initialization data packet to the Base Unit once every 15 seconds (or sooner if the tank level changes.) The CTM will time out of Initialization mode and will revert to the Normal operating mode after 60 minutes. This is done to conserve battery life and to ensure that the CTM continues reporting to the Host once the installer has left the site. See the operating manual for the type of Base Unit that you are using for instructions on putting the Base Unit into Initialization mode.

### CONFIGURATION Mode: (One Programming Magnet in Both OFF and INIT Positions.)

Configuration mode is used to change one or more of the internal CTM configuration parameters. When in this mode, system (CTM) or application (tank level) operating characteristics can be changed using a PDU.

Changes made with a PDU are reported to the Host once the CTM is returned to Normal mode. If field configuration is enabled in the Host, the Host will store the changes to its configuration database, and will send the changes back to the CTM to confirm acceptance of the changes. If field configuration is not enabled in the Host, the Host will overrule the CTM and will send the previous configuration back to the CTM. The CTM will time out of Configuration mode and return to Normal mode if it has not received a configuration command from the PDU for 15 minutes. This is done to conserve battery life and to ensure that the CTM continues reporting to the Host once the installer has left the site.

C. Reporting To Host

The CTM reports to the Host on a schedule determined by the Host configuration. The reporting schedule can range from once per hour to once per month. The report interval will directly affect battery life as the cellular sub-system is the major consumer of power in the CTM. It is not recommended to leave the CTM configured with an hourly reporting schedule for more than 24 hours as it will shorten battery life and will lead to excessive cellular data charges.

In addition to scheduled reporting, the CTM will contact the Host to report CTM configuration changes, tank level events, and high or low temperature conditions.

D. Tank Level Measurement

The CTM wakes up and measures the level of the tank contents once per minute. This enables the CTM to be very responsive to changing tank level conditions and to more accurately qualify events such as tank fills or tank draws. The tank level is reported in a number ranging from 0 to 99, representing the tank level in percent full. This is the predominant measurement unit in the propane industry, and also serves well when monitoring low pressure fuels such as gasoline, diesel fuel, heating oil, etc.

E. Tank Level Events and Conditions

The CTM tracks and qualifies a number of different tank level events and conditions. Qualification of a tank level event or condition will cause the CTM to report to the Host ahead of its scheduled report time. A tank level event such as a tank fill is a one time event and will be reported and then cleared from the tank status. A tank level condition such as a low tank level will be reported, but will not be cleared from the tank status until the condition is no longer true. The following is a summary of the tank level events and conditions supported by the CTM. The configuration parameters referred to in this section can be referenced in the “Application Configuration” section of this document.
Tank Fill Event: A tank fill event will be qualified by the CTM when the tank level increases by the configured amount.
Tank Draw Event: A tank draw event will be qualified by the CTM when the tank level has decreased by the configured amount within one hour. A tank draw event will NOT be qualified if the tank level has dropped to 0% (bad or missing sensor).
Tank Level Change Event: A tank level change event will be qualified by the CTM when the tank level has moved above or below the configured tank level change threshold since the last report to the Host. This threshold can be positive or negative, depending on if the user is looking to track a rising or falling tank level.
Tank Critical High Condition: A tank critical high condition will be qualified by the CTM when the tank level has risen above the configured tank critical high threshold.
Tank Warning High Condition: A tank warning high condition will be qualified by the CTM when the tank level has risen above the configured tank warning high threshold.
Tank Warning Low Condition: A tank warning low condition will be qualified by the CTM when the tank level has dropped below the configured tank warning low threshold.
Tank Critical Low Condition: A tank critical low condition will be qualified by the CTM when the tank level has dropped below the configured tank critical low threshold.
Missing Sensor Condition: A bad or missing sensor condition will be qualified by the CTM when the tank level has dropped to 0% for a pre-determined amount of time. The qualification of this condition is not configurable.

F. Temperature Alarms

The CTM contains an accurate temperature measurement device and can be used to track ambient temperature at the installation site. The CTM also has configurable high and low temperature alarms and can be used to report abnormal temperature conditions to the Host. The CTM will report a new high or low temperature alarm to the Host, and will also report to the Host once the high or low temperature condition no longer exists.

Keep in mind that measured temperatures will be greatly affected by direct sunlight and somewhat affected by night time thermal radiation from the tank if installed on top of the tank.

G. Low Battery Notification

A low battery condition will not immediately trigger a report to the Host, but it will set a CTM system status flag that will be picked up by the Host at the next scheduled or event report.

IV. Portable Diagnostic Unit

A. General

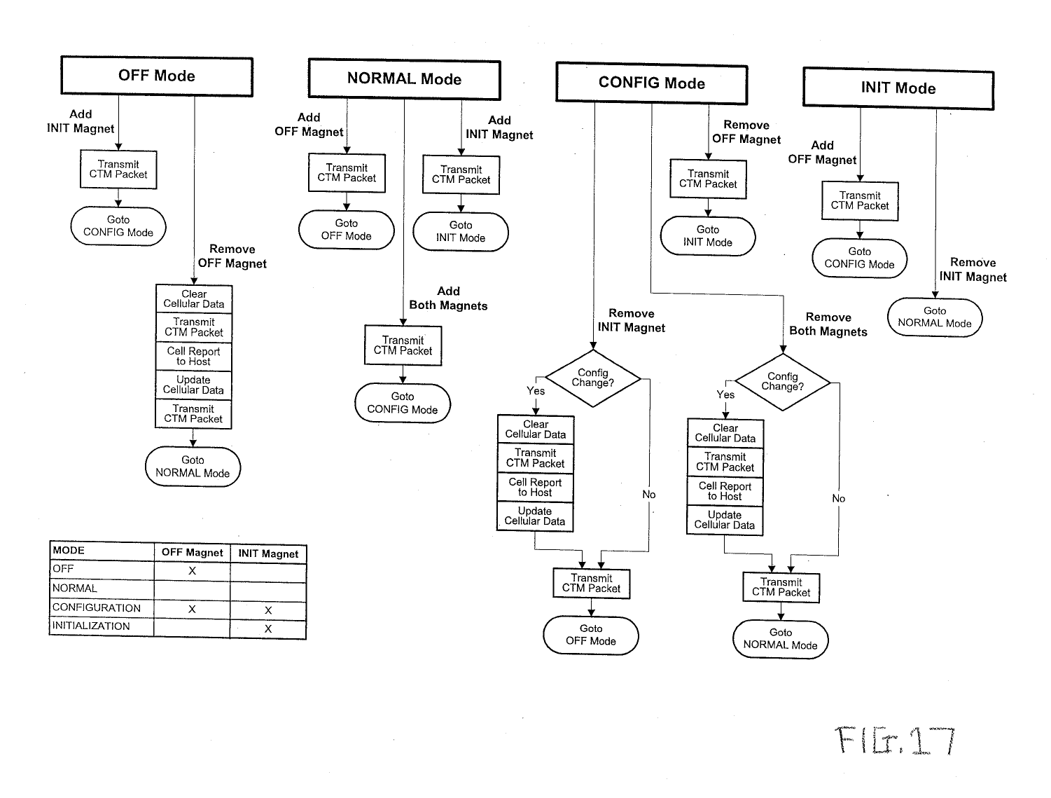

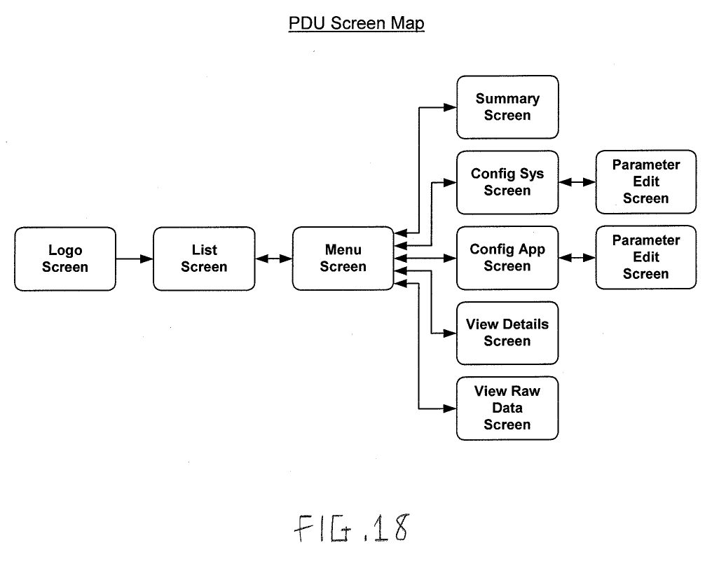

Referring to FIG. 18, the handheld WESROC® RMS Portable Diagnostic Unit (PDU) is used to configure and monitor the status of the WESROC® RMS Cellular Tank Monitor (CTM). This valuable device should be considered an essential part of any installation tool kit. The following is a summary of the sections of the PDU interface that are designed for use with the CTM. A more detailed description of the operation of the PDU can be found in the WESROC® RMS Portable Diagnostic Unit Operation Manual.

A configuration data packet is required to be transmitted by the CTM before the PDU can be used to configure the CTM or view detailed data from the CTM. The CTM will transmit a configuration data packet before and after each report to the Host, when the CTM is placed in Configuration mode, and each time a configuration command is received from the PDU. The CTM must be in Configuration mode to respond to configuration commands sent by the PDU. A configuration command is sent from the PDU to the CTM each time the user changes a configuration parameter value and leaves a configuration parameter editing screen.

B. PDU Screens

Logo Screen: Referring to FIG. 19, this is the first screen displayed when the PDU is powered up. This screen will contain the Independent Technologies logo, or may contain your company logo if arrangements have been made for a custom logo. Press the right arrow key on the PDU to move to the List Screen. This screen will only be displayed once when the PDU is powered on.

List Screen: Referring to FIG. 20, each line on this screen represents a WESROC® RMS device that has transmitted a data packet in the recent past. The serial number of the device will be displayed on the left side of the screen. A configuration data packet from a CTM will be noted by the “CelMon” device label in the middle of the screen. The time since the last transmission from each device is listed on the right side of the screen. Press the up arrow or down arrow keys to select the desired device. Press the right arrow key to move to the Menu Screen.

Menu Screen: Referring to FIG. 21, this screen contains a list of screens that can be selected depending on what type of action you want to take. Press the up arrow or down arrow keys to select the desired screen. Press the right arrow key to move to the selected screen. Press the left arrow key to return to the List Screen. At the bottom of this screen is a Ping command that can be executed by pressing the right arrow key. The ping command can be used to check for a simple response from the CTM.

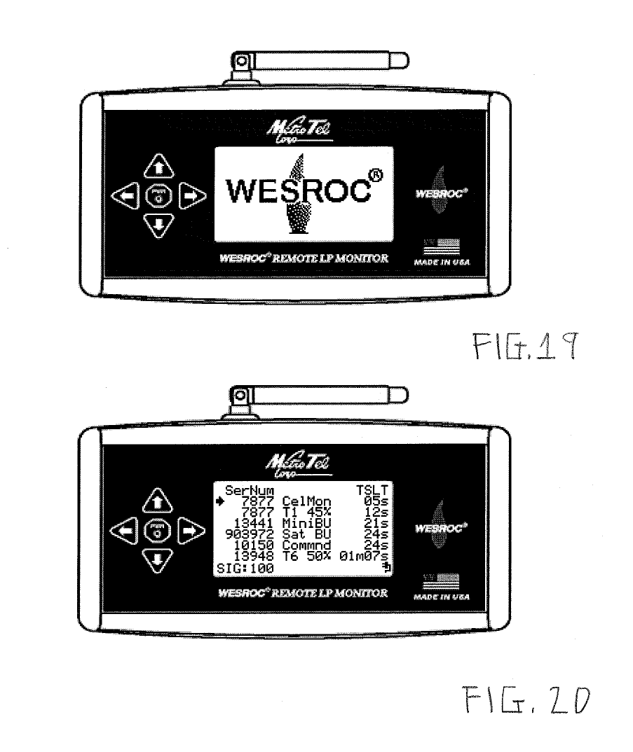

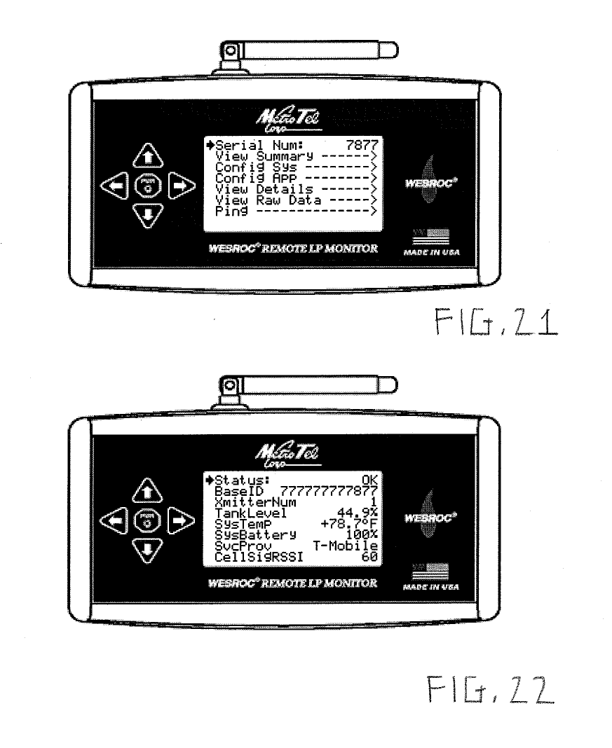

Summary Screen: Referring to FIG. 22, this screen contains a quick snapshot of the status of the CTM, the tank level, and the cellular network conditions during the last report to the Host. Press the left arrow key to return to the Menu Screen.

System Configuration Screen: Referring to FIG. 23, this screen contains a list of CTM system configuration parameters. Press the up arrow and down arrow keys to select a configuration parameter to change. Not all of the system configuration parameters are visible on the screen at the same time. Press the right arrow key to move to the selected configuration parameter editing screen. Press the left arrow key to return to the Menu Screen.

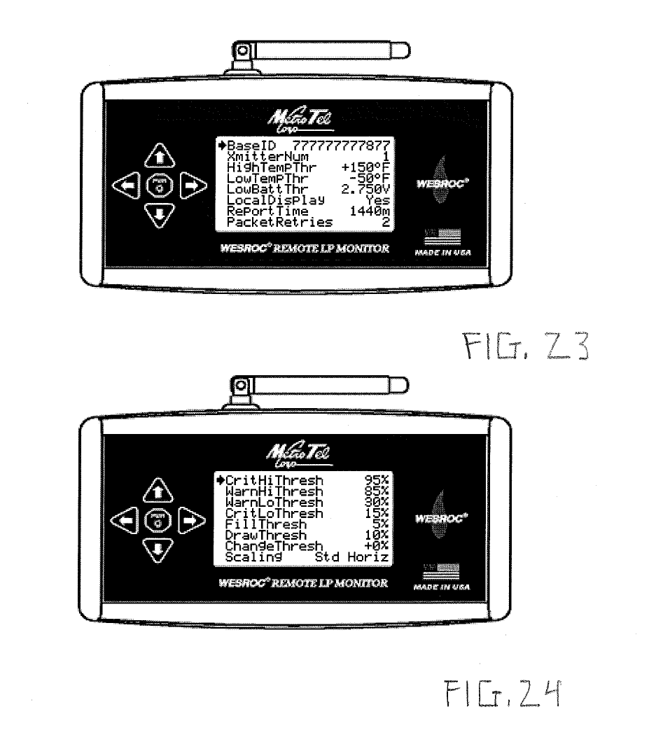

Application Configuration Screen: Referring to FIG. 24, this screen contains a list of application (tank level) configuration parameters. Press the up arrow and down arrow keys to select a configuration parameter to change. Not all of the application configuration parameters are visible on the screen at the same time. Press the right arrow key to move to the selected configuration parameter editing screen. Press the left arrow key to return to the Menu Screen.

View Details Screen: Referring to FIG. 25, this is a series of screens that can be used to view detailed information about the CMT system status, the tank level status and history, and information about the cellular network during the last report to the Host. Press the up arrow and down arrow keys to move between the various detail screens. Press the left arrow key to return to the Menu Screen.

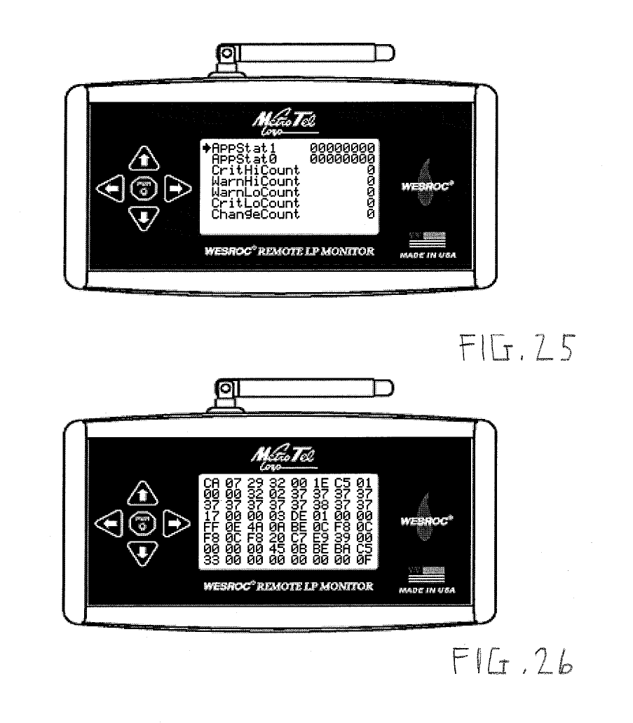

View Raw Data Screen: Referring to FIG. 26, this is a series of screens that can be used to view the raw data contained in the data packets transmitted from the CTM to the PDU. This information will only be useful for very rare and specific diagnostic purposes. Press the up arrow and down arrow keys to move between the various raw data screens. Press the left arrow key to return to the Menu Screen.

V. System Configuration Parameters

A. General

The WESROC® RMS Cellular Tank Monitor system configuration parameters can be modified using the WESROC® RMS Portable Diagnostic Unit (PDU). These configuration parameters can also be modified by the WESROC® RMS Host System (Host) during a report.

B. Parameter List:

Base ID: Used to identify a particular CTM device in the Host database.

### Min: 000000000001; Max: 999999999999

Default: 99xxxxxxxxxx; Disable: N/A
Primary IP Address: The IP address used to report to the primary Host.

### Min: 0.0.0.1; Max: 255.255.255.255

Default: [server dependent]; Disable: 0.0.0.0 (Do not report.)
Primary IP Port: The IP port number used to report to the primary Host.

### Min: 1; Max: 65535

Default: [server dependent]; Disable: 0 (Do not report.)
Secondary IP Address: The IP address used to report to the backup Host.

### Min: 0.0.0.1; Max: 255.255.255.255

Default: [server dependent]; Disable: 0.0.0.0 (Do not report.)
Secondary IP Port: The IP port number used to report to the backup Host.

### Min: 1; Max: 65535

Default: [server dependent]; Disable: 0 (Do not report.)
Host Response Timeout: The maximum number of seconds that the CTM will wait for a response from the Host before sending a data packet retry.

### Min: 5; Max: 60

### Default: 15; Disable: N/A

Maximum Packet Retries: The maximum number of times that the CTM will retry sending a data packet to the Host before terminating a report.

### Min: 1; Max: 8

### Default: 2; Disable: N/A

Report Interval: The number of minutes until the next scheduled report to the Host.

### Min: 60 (One Hour); Max: 65535 (45.5 Days)

### Default: 1440 (24 Hours); Disable: N/A

Low Battery Threshold (mV): The low battery threshold for the CTM system battery.

### Min: 2500; Max: 3600

### Default: 2808 (78%); Disable: N/A

High Temperature Threshold: The high temperature alarm threshold in degrees F.

### Min: −67 F; Max: +302 F

Default: +150 F (Effectively Disabled); Disable: 0×8000 (From host only.)
Low Temperature Threshold: The low temperature alarm threshold in degrees F.

### Min: −67 F; Max: +302 F

Default: −50 F (Effectively Disabled); Disable: 0×8000 (From host only.)
Local Display Mode: Enable Local Display mode to configure the CTM to transmit ISM radio data packets to a local display device. Disable if not used to maximize battery life.

### Range: Enable or Disable

### Default: Disabled

ISM Transmitter Number: Sets the transmitter number of the CTM. The local display device will display this number next to the displayed tank level. This feature is very useful in multiple tank applications.
Min: 1; Max: 127 (Maximum of 8 on handheld and current local display devices.)

### Default: 1; Disable: N/A

VI. Application Configuration Parameters

A. General

The WESROC® RMS Cellular Tank Monitor application (tank level) configuration parameters can be modified using the WESROC® RMS Portable Diagnostic Unit (PDU). These configuration parameters can also be modified by the WESROC® RMS Host System (Host) during a report.

B. Parameter List:

Sensor Scaling The sensor output scaling to be used to calibrate the CTM to the type of tank and gauge being monitored.

Min: 1; Max: 255 (Not all used at this time—see current list below.)

Default: 1 (Small horizontal tank dial.); Disable: N/A

1=Std Horiz (small dial horizontal propane or fuel tank)
2=Lg Dial (large dial horizontal tank—use on large dials with black Rochester sensor)
3=420# Vert (420# vertical propane cylinder)
4=200# Vert (200# vertical propane cylinder with Taylor type “A” dial)
5=Liquid CO2 (vertical liquid CO2 cylinder—do not use, special use only)
6=Fuel Horiz (small dial horizontal fuel tank—no longer used, use Std Horiz scaling)
7=Flat (no dial scaling correction—special use only)
8=20 k Horiz (20 k gallon horizontal fuel tank—do not use, special use only)
9=4-20 mA (monitor 4-20 mA industrial current loop—special use only)
10=ITC LgDial (large dial horizontal tank—use on large dials with ITC Precision Sensor)
Tank Fill Threshold: The tank fill event qualification amount in percent full.

### Min: 3%; Max: 95%

### Default: 10%; Disable: 0%

Tank Draw Threshold: The tank draw event qualification amount in percent full.

### Min: 3%; Max: 95%

### Default: 15%; Disable: 0%

Critical High Threshold: The tank critical high condition level in percent full.

### Min: 5%; Max: 95%

### Default: 0%; Disable: 0%

Warning High Threshold: The tank warning high condition level in percent full.

### Min: 5%; Max: 95%

### Default: 0%; Disable: 0%

Warning Low Threshold: The tank warning low condition level in percent full.

### Min: 5%; Max: 95%

### Default: 30%; Disable: 0%

Critical Low Threshold: The tank critical low condition level in percent full.

### Min: 5%; Max: 95%

### Default: 15%; Disable: 0%

Level Change Threshold: The tank level change qualification amount in percent full. Set to a negative number to track a tank level decrease; set to a positive number to track a tank level increase.

### Min: −95%; Max: +95%

### Default: 0%; Disable: 0%; Invalid: +1 to +4%, −1% to −4%

Gain Adjust: Used to compensate for tank and gauge size mismatches and gauge gain calibration errors. For special applications only.

### Min: −10.00×(Gain of −10.00); Max: +10.00×(Gain of +10.00)

### Default: +1.00×(Gain of +1.00)

### Disable: N/A; Invalid: +0.00

Offset Adjust: Used to compensate for gauge offset calibration errors.
For special applications only.

### Min: −100.00; Max: +100.00

### Default: +0.00; Disable: N/A

VII. Battery Replacement

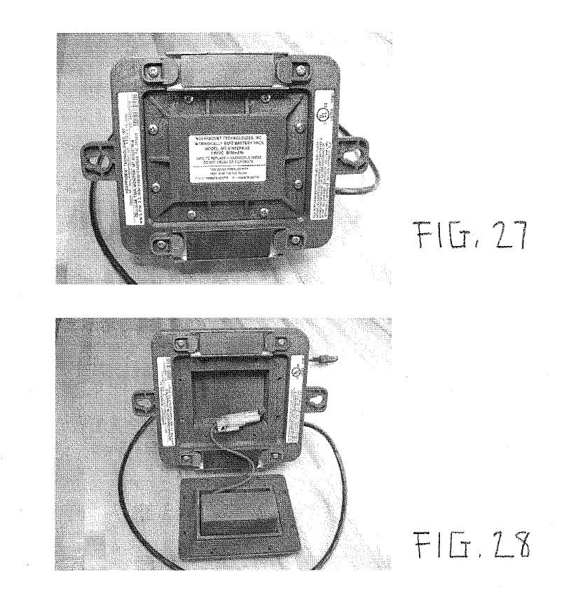

Referring to FIGS. 27 and 28, the WESROC® RMS Cellular Tank Monitor (CTM) uses a field replaceable, intrinsically safe battery pack designed and supplied by Independent Technologies, Inc. The CTM has been designed to operate on a very small amount of power, but eventually the battery pack will need replacement. Because the battery pack is intrinsically safe, the battery pack can be replaced at the tank without needing to remove the CTM to a safe location. The following steps explain how to replace the battery pack:
1. Remove the eight screws from around the perimeter of the battery pack.
2. Remove the battery pack from the bottom of the CTM enclosure and disconnect the battery pack connector.
3. Connect the new battery pack to the CTM and arrange the battery pack cable to clear internal obstructions.
4. Replace the battery pack into the bottom of the CTM enclosure and replace the eight screws. Do NOT over tighten the screws and strip the threads from the bottom of the CTM enclosure.

VII. Summary of Installation Method

1) Complete the CTM Installation Information Worksheet on the reverse side of this document and send it to your WESROC host administrator. You MUST record the CTM serial number on the worksheet to match the installation location to the monitoring hardware.

2) If not already present, install the correct Rochester remote ready dial or ITC large dial assembly on the tank gauge. Remote ready dials and large dial assemblies are available for a wide variety of gauge types.

3) Remove the CTM from the box and make sure the small round programming magnet is secured in the OFF position on the CTM enclosure. (Off mode.)

4) Mount the CTM on or near the tank to be monitored using the attached mounting magnets or a mounting bracket. Try not to place the CTM right next to a vertical metal object such as a tank dome or hood. Cellular signal reception will be affected by distance and by obstructions such trees, mountainous terrain, buildings, metal structures, large vehicles parked nearby, etc. The best signal reception will be achieved with a line of sight path between the CTM and the cell tower. This is rarely the case in the real world, but should be kept in mind when selecting a mounting location for the CTM. Versions of the CTM with a longer sensor cable allow for mounting the CTM a few feet away from the tank to improve cellular reception.

5) Connect the CTM sensor cable to the remote ready dial. Large dial installations use an in-line connector to attach the CTM to the dial. When attaching the connector, make sure the connector is fully seated and that the locking ring has been fully turned to ensure a weather tight seal.

6—Option A) Force a configuration report to Host using the default CTM configuration settings.
Remove the programming magnet from the OFF position on the CTM and step away. (Normal mode.) Do not block the cellular signal with your body while the CTM is reporting to the Host.

6—Option B) Make CTM configuration settings changes and force a configuration report to Host.
Place programming magnets in the OFF and INIT positions on the CTM. (Configuration mode.)
Make system and application configuration changes using a WESROC Portable Diagnostic Unit (PDU).
Remove both programming magnets from the CTM at the same time and step away. (Normal mode.) Do not block the cellular signal with your body while the CTM is reporting to the Host.

The CTM will now perform a configuration report to the Host. A report is typically completed in 30 to 40 seconds, but can take up to 3 minutes under weak cellular signal conditions. The CTM does not provide any direct feedback regarding report success or failure; therefore it is recommended to use a handheld PDU when performing CTM installations.

7) Once a successful report has been completed, secure the sensor cable using the appropriate fasteners (cable ties, etc.). Route the sensor cable to make sure the cable will not be damaged by a moving object such as a tank dome or hood.

8) (Optional) Initialize the CTM to a WESROC Base Unit if you are using the local display feature.
Place a programming magnet in the INIT position on the CTM. (Initialization mode.)
Place the Base Unit into Initialization mode.
Wait for the CTM tank level to appear on the Base Unit display.
Remove programming magnet from the CTM, and return the Base Unit to normal operation.

Remove all programming magnets from the CTM enclosure before leaving the installation site.

The embodiments above are chosen, described and illustrated so that persons skilled in the art will be able to understand the invention and the manner and process of making and using it. The descriptions and the accompanying drawings should be interpreted in the illustrative and not the exhaustive or limited sense. The invention is not intended to be limited to the exact forms disclosed. While the application attempts to disclose all of the embodiments of the invention that are reasonably foreseeable, there may be unforeseeable insubstantial modifications that remain as equivalents. It should be understood by persons skilled in the art that there may be other embodiments than those disclosed which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

The invention claimed is:

1. A system for monitoring the level and use of fluids in a storage tank, comprising a sensor unit adapted to be communicatively connected to a storage tank, the sensor unit measuring the level of fluid in the storage tank and transmitting fluid level data externally via at least a cellular data communication link, a remote host unit adapted to be disposed remotely from the storage tank, the host unit receiving fluid level data from the sensor unit via the cellular data communication link, and a base unit adapted to be disposed in the vicinity of the storage tank by a user, the base unit receiving fluid level data from the sensor unit via the cellular data communication link or via an RF link.

2. A sensor unit adapted to be communicatively connected to a fluid storage tank, the sensor unit measuring the level of fluid in the storage tank and transmitting fluid level data to a remote means to receive and process information via at least a cellular data communication link.

3. A host unit adapted to be disposed remotely from a fluid storage tank, the host unit receiving fluid level data from a sensing means which is communicatively connected to the storage tank, the host unit receiving fluid level data via a cellular data communication link.

4. A base unit adapted to be disposed in a vicinity of a fluid storage tank, the base unit receiving fluid level data from a sensing means communicatively connected to the storage tank via a cellular data communication link or an RF link.

5. A method for monitoring the level and use of fluids in a storage tank, comprising
a. providing a monitoring system including
i. a sensor unit adapted to be communicatively connected to a storage tank, the sensor unit measuring the level of fluid in the storage tank and transmitting fluid level data externally via at least a cellular data communication link,
ii. a host unit adapted to be disposed remotely from the storage tank, the host unit receiving fluid level data from the sensor unit via the cellular data communication link, and
iii. at base unit adapted to be disposed in the vicinity of the storage tank, the base unit receiving fluid level data from the sensor unit via the cellular data communication link or an RF link.
b. connecting the sensor unit to the storage tank and monitoring the level of fluid in the storage tank;
c. communicating fluid level data from the sensor to the host unit via the cellular data link;
d. processing fluid level data at the host unit;
e. communicating fluid level data from the sensor to the base unit via the cellular data link or an RF link; and
f. processing fluid level data at the base unit.
